(19) United States
(12) Patent Application Publication
(10) Pub. No.: US 2025/0327257 A1
(43) Pub. Date: Oct. 23, 2025

(54) SNOW BLOWER

(71) Applicant: Milwaukee Electric Tool Corporation, Brookfield, WI (US)

(72) Inventors: Quy V. Nguyen, Milwaukee, WI (US); Zachary D. Bernaden, Milwaukee, WI (US); Jonathan S. Keller, Menomonee Falls, WI (US); Mark J. Frykman, Mequon, WI (US); Brooke E. Duvall, Burlington, WI (US); Kyle T. Fischer, Jackson, WI (US); Nicholas J. Block, Milwaukee, WI (US); Shashank Shetty, Windsor, CA (US); Alexandra K. Reglin, Hartford, WI (US); Nathan T. Armstrong, Fox Point, WI (US); Daniel J. Eutizzi, Waukesha, WI (US); Brian A. Cornell, West Allis, WI (US); Jacob T. DeGroot, Black Creek, WI (US); Timothy Rodenkirch, Slinger, WI (US)

(21) Appl. No.: 19/182,795

(22) Filed: Apr. 18, 2025

Related U.S. Application Data
(60) Provisional application No. 63/636,127, filed on Apr. 19, 2024.

(51) Int. Cl. E01H 5/09; F16H 37/12

(52) U.S. Cl. CPC E01H 5/098; F16H 37/122

(57) ABSTRACT

A snow blower includes a frame defining an auger housing, an inlet opening, and an outlet opening. The outlet opening may be circumferentially bounded about a chute axis. The snow blower also includes a rotatable auger, one or more wheels mounted to the frame apart from the rotatable auger to support the snow blower, a chute body extending from the frame along the chute axis, and a chute drivetrain assembly. The rotatable auger may be mounted to the frame rearward from the inlet opening and below the outlet opening. Additionally, the chute drivetrain assembly may include a chute gear coupled to the frame and defining at least a portion of the outlet opening and a chute lever operatively coupled to the chute gear for rotating the chute body about the chute axis. The chute gear may be configured to rotate the chute body about the chute axis.

### FIELD OF THE DISCLOSURE

The present disclosure relates generally to outdoor power tools, such as snow blower power tools.

### BACKGROUND OF THE DISCLOSURE

Power tools are generally utilized to make working conditions easier. For example, snow blowers eliminate the need for shoveling snow. Instead of manually lifting snow from a surface (e.g., a driveway or sidewalk) to move the snow therefrom, the operator can push or walk a snow blower through the snow. The snow blower lifts the snow and discharges it a distance from the underlying surface. Typically, this involves moving snow from a rotating auger to a downstream chute that can direct the moving snow away from the snow blower. In this regard, snow blowers make snow removal easier than previous manual operations.

### BRIEF DESCRIPTION OF THE DISCLOSURE

Although snow blowers can greatly reduce the amount of human effort to clear an area of snow, existing appliances still maintain certain drawbacks during use. For instance, in a battery-powered snow blower, it may be difficult for a user to know what the condition of one or more batteries may be at any given moment. Additionally or alternatively, safety features may be useful to prevent inadvertent activation of the auger or wheels of the snow blower. However, battery-powered snow blowers do not generally have a fuel-cutoff or other mechanical mechanism to allow for the bail bar to stop operation of the lawnmower. Further additionally or alternatively, the cold temperatures in which a snow blower is often used may create discomfort, especially for a user's hands even when using gloves.

Accordingly, snow blowers, features, or methods of operation are desired in the art. In particular, systems or methods that enhance ease of use and convenience for a user would be advantageous.

Aspects and advantages of the invention will be set forth in part in the following description, or may be obvious from the description, or may be learned through practice of the invention.

In an exemplary aspect of the present disclosure, a snow blower is provided. The snow blower may include a frame defining an auger housing, an inlet opening, and an outlet opening. The outlet opening may be circumferentially bounded about a chute axis. The snow blower may also include a rotatable auger disposed in the auger housing, one or more wheels mounted to the frame apart from the rotatable auger to support the snow blower, a chute body extending from the frame along the chute axis above the outlet opening, and a chute drivetrain assembly coupled to the frame and the chute body. The rotatable auger may be mounted to the frame rearward from the inlet opening and below the outlet opening to motivate snow to the outlet opening. Additionally, the chute drivetrain assembly may include a chute gear coupled to the frame and defining at least a portion of the outlet opening and a chute lever operatively coupled to the chute gear for rotating the chute body about the chute axis. The chute gear may be configured to rotate the chute body about the chute axis.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of a snow blower in accordance with exemplary embodiments of the present disclosure.

FIG. 2 is a side elevation view of a portion of a snow blower in accordance with exemplary embodiments of the present disclosure.

FIG. 3 provides an overhead perspective view of a battery compartment of a snow blower in accordance with exemplary embodiments of the present disclosure.

FIG. 4 provides another perspective view of a battery compartment of a snow blower in accordance with exemplary embodiments of the present disclosure.

FIG. 5 provides a perspective view of a portion of the exemplary battery compartment of FIG. 4, wherein a deflector plate is provided in an obstructed position.

FIG. 6 provides a perspective view of a portion of the exemplary battery compartment of FIG. 4, wherein a deflector plate is provided in an unobstructed position.

FIG. 7 provides a perspective view of a portion of battery compartment of a snow blower in accordance with exemplary embodiments of the present disclosure, wherein various body panels of the snow blower have been removed for clarity.

FIG. 8 provides a cross-sectional perspective view of a mounted portion of the exemplary battery compartment of FIG. 7.

FIG. 9 provides an overhead perspective view of a battery compartment of a snow blower in accordance with exemplary embodiments of the present disclosure.

FIG. 10 provides a partially exploded perspective view of a portion of a snow blower, including a top body panel of the frame, according to exemplary embodiments of the present disclosure.

FIG. 11 provides a top perspective view of the exemplary top body panel, in isolation, of FIG. 10.

FIG. 12 provides a bottom perspective view of the exemplary top body panel of a snow blower according to exemplary embodiments of the present disclosure.

FIG. 13 provides a perspective view of a portion of an auger assembly of a snow blower in accordance with exemplary embodiments of the present disclosure.

FIG. 14 provides a perspective view of a portion of the auger assembly, wherein a portion of the auger housing has been removed for clarity.

FIG. 15 provides a top perspective view a portion of an auger housing, in isolation, of a snow blower according to exemplary embodiments of the present disclosure.

FIG. 16 provides a perspective view of a portion of a handle assembly and control panel of a snow blower in accordance with exemplary embodiments of the present disclosure.

FIG. 17 provides a perspective view of a portion of a handle assembly and control panel of a snow blower in accordance with exemplary embodiments of the present disclosure.

FIG. 18 provides a perspective view of a bottom portion of the control panel of a snow blower in accordance with exemplary embodiments of the present disclosure.

FIG. 19 provides a perspective view of a portion of a bail control bar and sensor array within a control panel of a snow blower according to exemplary embodiments of the present disclosure wherein the bail control panel is in an engaged position.

FIG. 20 provides a perspective view of a portion of a bail control bar and sensor array within a control panel of a snow blower according to exemplary embodiments of the present disclosure wherein the bail control panel is in a released position.

FIG. 21 provides a perspective view of a portion of a handle assembly and control panel of a snow blower in accordance with exemplary embodiments of the present disclosure.

FIG. 22 provides a sectional elevation view of a portion of a control panel of a snow blower in accordance with exemplary embodiments of the present disclosure.

FIG. 23 provides a perspective view of a portion of a hand warmer and a handle assembly of a snow blower in accordance with exemplary embodiments of the present disclosure.

FIG. 24 provides a front elevation view of a snow blower in accordance with exemplary embodiments of the present disclosure.

FIG. 25 provides a front elevation view of a portion of a snow blower in accordance with exemplary embodiments of the present disclosure.

FIG. 26 provides a front elevation view of a portion of an auger of a snow blower in accordance with exemplary embodiments of the present disclosure.

FIG. 27 provides a side elevation view of a portion of an auger of a snow blower in accordance with exemplary embodiments of the present disclosure.

FIG. 28 provides a front elevation view of a portion of a snow blower in accordance with exemplary embodiments of the present disclosure.

FIG. 29 provides a cross-sectional perspective view of a portion of an auger assembly of a snow blower in accordance with exemplary embodiments of the present disclosure.

FIG. 30 provides a bottom perspective view of a portion of a snow blower in accordance with exemplary embodiments of the present disclosure.

FIG. 31 provides a bottom perspective view of a snow blower in accordance with exemplary embodiments of the present disclosure.

FIG. 32 provides a perspective view of a portion of a snow scraper assembly of a snow blower in accordance with exemplary embodiments of the present disclosure.

FIG. 33 provides another perspective view of a portion of a snow scraper assembly of a snow blower in accordance with exemplary embodiments of the present disclosure.

FIG. 34 provides a side elevation view of a portion of a snow blower, including an auger drivetrain, of a snow blower in accordance with exemplary embodiments of the present disclosure.

FIG. 35 provides a perspective view of a portion of an auger drivetrain of a snow blower in accordance with exemplary embodiments of the present disclosure.

FIG. 36 provides a cross-sectional perspective view of a portion of an auger drivetrain of a snow blower in accordance with exemplary embodiments of the present disclosure.

FIG. 37 provides a perspective view of a portion of a chute assembly of a snow blower in accordance with exemplary embodiments of the present disclosure.

FIG. 38 provides a perspective view of a portion of a drivetrain for a chute assembly of a snow blower in accordance with exemplary embodiments of the present disclosure.

FIG. 39 provides an overhead perspective view of a gear of the exemplary drivetrain of the chute assembly of FIG. 38.

FIG. 40 provides a magnified perspective view of a portion of the exemplary gear of FIG. 39.

FIG. 41 provides a cross-sectional elevation view of a portion of a drivetrain for a chute assembly of a snow blower in accordance with exemplary embodiments of the present disclosure.

FIG. 42 provides a cross-sectional perspective view of a portion of an auger and chute assembly of a snow blower in accordance with exemplary embodiments of the present disclosure.

FIG. 43 provides a bottom perspective view of a portion of an auger housing of a snow blower in accordance with exemplary embodiments of the present disclosure.

FIG. 44 provides a perspective view of a portion of a chute assembly of a snow blower in accordance with exemplary embodiments of the present disclosure.

FIG. 45 provides a perspective view of a deflector of a chute assembly of a snow blower in accordance with exemplary embodiments of the present disclosure.

FIG. 46 provides a cross-sectional perspective view of the exemplary deflector of FIG. 45.

FIG. 47 provides a magnified, cross-sectional, perspective view of a portion of the exemplary deflector of FIG. 46.

FIG. 48 provides a perspective view of a portion of a chute assembly of a snow blower in accordance with exemplary embodiments of the present disclosure, wherein portions of a deflector have been removed for clarity.

FIG. 49 provides a cross-sectional perspective view of the exemplary chute assembly of FIG. 48.

Repeat use of reference characters in the present specification and drawings is intended to represent the same or analogous features or elements of the present invention.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following; A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Exemplary aspects of the present disclosure may include one or more features to advantageously block a battery terminal from snow, such as when a battery is absent from a battery compartment. The battery terminal may be notably accessed or uncovered from the blocking features (e.g., automatically or without additional input from a user) by inserting a battery pack within the battery compartment or otherwise mating the battery pack to the battery terminal.

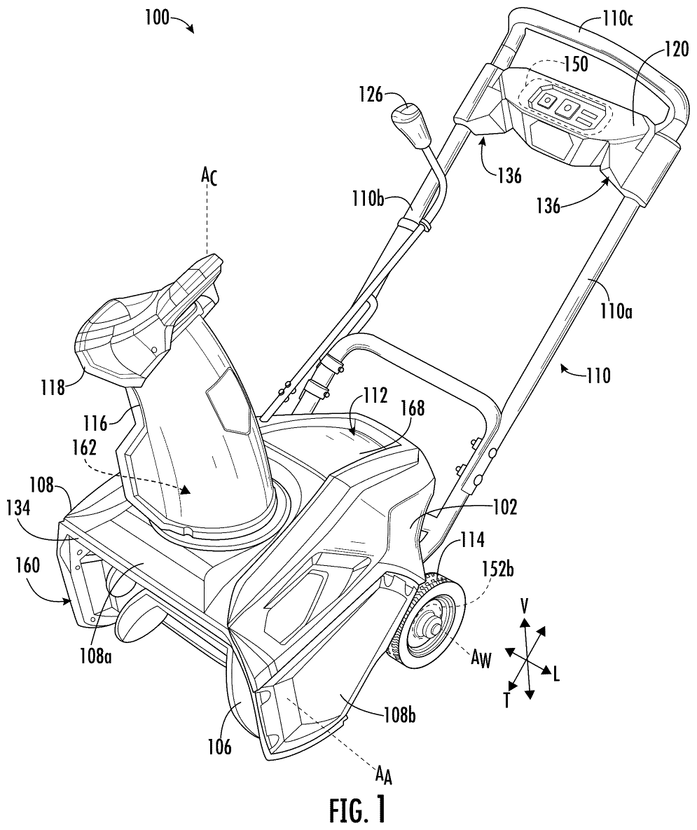

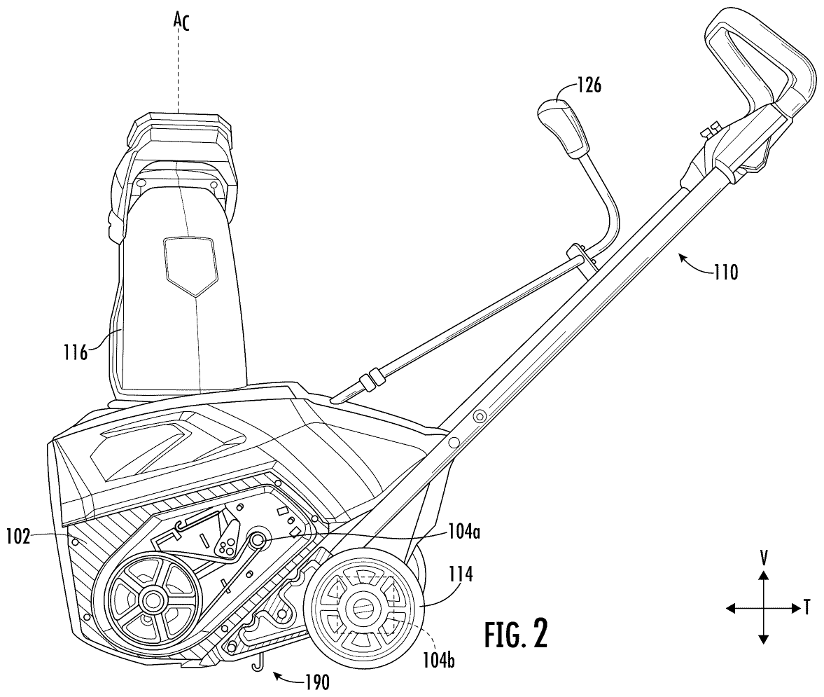

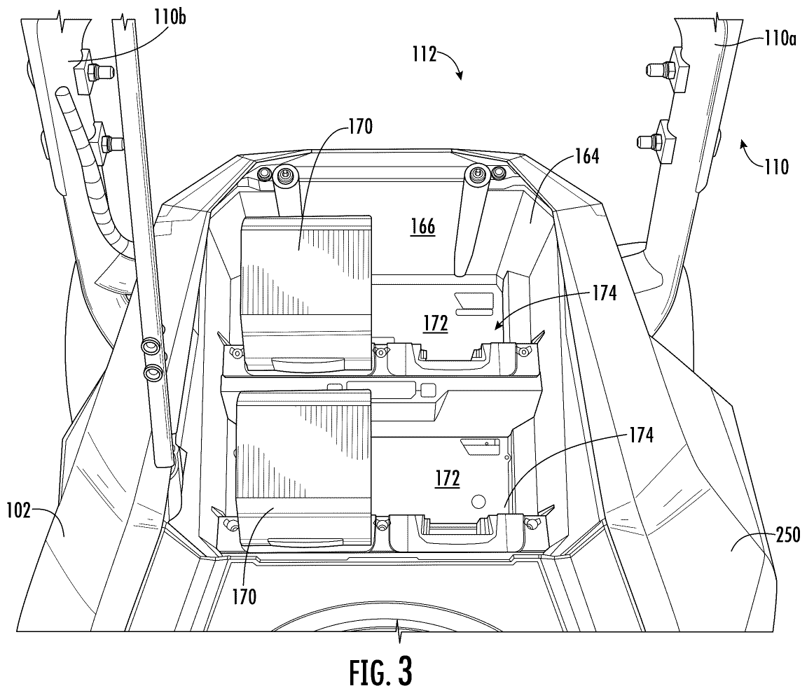

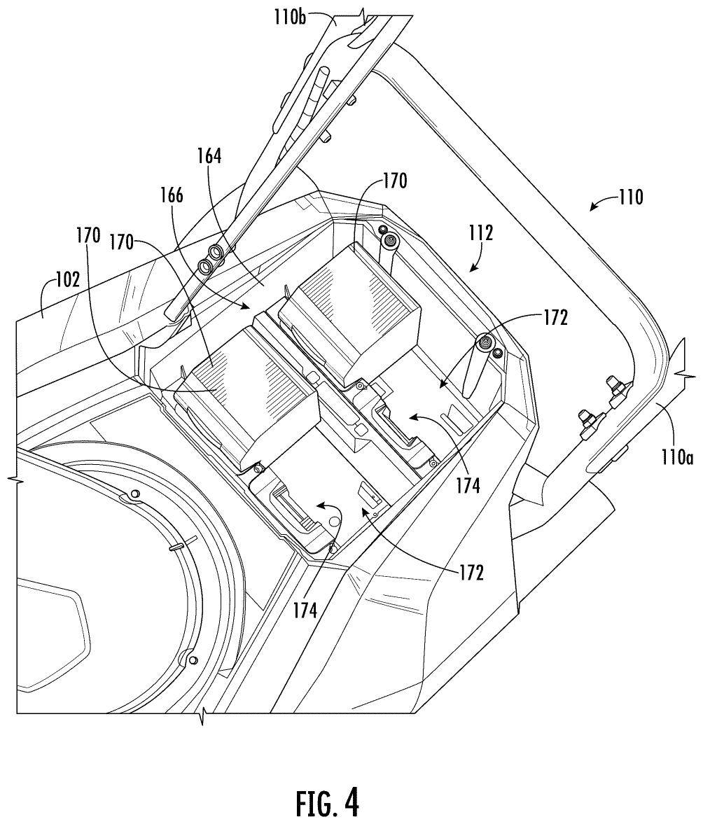

Referring now to the drawings, FIGS. 1 and 2 illustrate a snow blower 100 in accordance with various exemplary embodiments of the present disclosure. Generally, snow blower 100 defines a mutually orthogonal vertical direction V, lateral direction L, and transverse direction T. The snow blower 100 includes a frame 102, one or more motors 104 (e.g., element motor 104a or wheel motor 104b) and an auger 106 coupled (e.g., rotatably mounted) to the frame 102 (e.g., disposed in auger housing 108) to rotate about a defined auger axis AA. Snow blower 100 may further include a handle assembly 110 extending from the frame 102. As illustrated, the handle assembly 110 can extend from a rear end of the frame 102 in a generally vertical direction V. A battery compartment 112 having a cover 168 can be coupled to the frame 102 to receive one or more batteries or battery packs 170 (FIGS. 3 and 4) which can provide power to the one or more motors 104a, 104b (e.g., one more electric motors). In other embodiments, one or more motors 104a, 104b can include an engine powered by fuel. In such embodiments, a fuel storage tank (not illustrated) may be provided to store fuel for powering the engine.

The snow blower 100 is supported by one or more walking elements (e.g., wheels 114). Generally, one or more wheels 114 define a wheel axis A_{w} (e.g., parallel to the lateral direction L) about which the wheels 114 rotate. In optional embodiments, the wheels 114 are provided as a pair of driven wheels that can be driven or rotated by a discrete wheel motor 104b (e.g., separate from element motor 104a). As illustrated, the wheel motor 104b may be supported on the frame 102 apart from the element motor 104a. Although the driven wheels 114 may be motivated or rotated by wheel motor 104b, an operator or user may selectively push the snow blower 100 (e.g., manually).

It is noted that although the illustrated snow blower 100 is shown as a single-stage snow blower, the present disclosure is not limited to the same and may be applicable to any suitable snow blowing power tool, such as a dual-stage (e.g., impeller) snow blower, self-propelled snow blower, manually propelled or push snow blower, etc.

In some embodiments, a controller 150 may be provided in operative communication with one or more components of snow blower 100 (e.g., motors 104a, 104b, sensors 152a, 152b, etc.). The controller 150 may include a memory and one or more microprocessors, CPUs or the like, such as general or special purpose microprocessors operable to execute programming instructions or micro-control code associated with operation of snow blower 100. The memory may represent random access memory such as DRAM, or read only memory such as ROM or FLASH. In some embodiments, the processor executes non-transitory programming instructions stored in memory. For certain embodiments, the instructions include a software package configured to operate snow blower 100 or execute an operation routine. The memory may be a separate component from the processor or may be included onboard within the processor. Alternatively, controller 150 may be constructed without using a microprocessor (e.g., using a combination of discrete analog or digital logic circuitry; such as switches, amplifiers, integrators, comparators, flip-flops, AND gates, and the like) to perform control functionality instead of relying upon software.

Controller 150 may be positioned in a variety of locations throughout snow blower 100. Input/output (“I/O”) signals may be routed between controller 150 and various operational components of snow blower 100. One or more components of snow blower 100 may be in operative communication (e.g., electric communication) with controller 150 via one or more conductive signal lines or shared communication busses.

In optional embodiments, one or more operational sensors 152a, 152b are provided on snow blower 100 in operative (e.g., wired or wireless) communication with controller 150. Generally, such operational sensors 152a, 152b are configured to detect one or more operational conditions of the snow blower 100 and transmit signals corresponding to the same (e.g., to controller 150). Such operational conditions may be related to performance of the snow blower 100. As an example, a motor sensor 152a may be provided (e.g., at controller 150) to detect a motor loading signal received from the auger motor 104a according to an operational load (e.g., voltage draw) on the auger motor 104a. Such motor loading signals and sensors 152a, 152b for the same are generally understood. As an additional or alternative, example, a speed sensor 152b may be mounted on frame 102 and configured to detect a velocity of the snow blower 100. The detected velocity may generally correspond to forward movement of the snow blower 100. For instance, speed sensor 152b may detect velocity based on a rotational speed of one or more wheels 114. To that end, and as would be understood the speed sensor 152b may include a rotational sensor (e.g., Hall effect sensor, inductive sensor, eddy-current sensor, photodiode array, etc.) be configured to detect rotational movement at the wheels 114 (or an axle thereof).

Optionally, the snow blower 100 can include one or more lighting elements (e.g., one or more light emitting diodes, commonly referred to as LEDs) configured to illuminate one or more areas of the environment in which the snow blower 100 is operating. For example, the snow blower 100 can include one or more light 134 (e.g., including one or more light emitting diodes, fluorescent bulbs, halogen bulbs, incandescent bulbs, etc.) disposed on the auger housing 108. The light 134 can be disposed on a front portion of the auger housing 108 so as to illuminate an area in front of the snow blower 100 during operation (e.g., an area of snow to be treated with the snow blower 100). Additionally or alternatively, the snow blower 100 can include one or more light or light units 136 (e.g., including one or more light emitting diodes, fluorescent bulbs, halogen bulbs, incandescent bulbs, etc.) configured to illuminate a path cleared by the snow blower 100. For instance, the light unit(s) 136 can be mounted on the handle assembly 110, a control panel 120, or any other suitable location to illuminate in a direction rearward from a path cleared by the auger 106.

The auger housing 108 generally houses the auger 106 (e.g., such that the auger 106 is housed below the top wall 108a and rearward from the front opening). Moreover, auger housing 108 can be in communication (e.g., fluid communication) with a chute 116. Moreover, the auger housing 108 can be connected with the chute 116 mechanically, electrically, or both. The chute 116 can extend, for example, above the auger housing 108. The chute 116 can direct discharged snow in a desired direction. In an embodiment, the chute 116 can rotate about a (e.g., vertical) chute axis Ac. The chute 116 can include a moveable interface 118 configured to rotate the discharge direction about a horizontal axis. In this regard, the direction and height of discharged snow can be controlled. In certain instances, the direction of at least one of the chute 116 and moveable interface 118 can be controlled by the operator at the handle assembly 110. For instance, a chute lever 126 may be provided on the handle assembly 110 to selectively rotate the chute 116. Additionally or alternatively, a movable flap lever may be provided on the chute 116 to selectively rotate the moveable interface 118.

In certain embodiments, handle assembly 110 include a top handle 110c (e.g., as an unbroken unitary piece or having left and right portions to receive a user's left and right hands, respectively). One or more inputs for controlling snow blower 100 may be provided on or proximal to top handle 110c. Although top handle 110c is shown as a single-piece construction handle having left and right portions to receive a user's left and right hands, respectively. In other instances, the handle assembly 110 can include a multi-piece construction (e.g., having multiple discrete handles to receive a user's hands). The top handle 110c can be coupled to one or more additional portions, which extend from the frame 102 to the first and second handles 110a and 110b (e.g., to support the top handle 110c or permit selective height adjustments or storage configurations of the handle assembly 110).

The auger housing 108 generally houses the auger 106. As shown, auger housing 108 may include multiple walls, which house or at least partially enclose auger 106. For instance, auger housing 108 may include a top wall 108a vertically bounding or disposed above auger 106 (e.g., such that the auger 106 is housed below the top wall 108a), a pair of side walls 108b laterally bounding auger 106, and a rear wall 108c transversely bounding or disposed rearward from auger 106. Generally, auger housing 108 defines two or more openings to permit snow therethrough. For instance, auger housing 108 may define an inlet opening 160 (e.g., at a front portion of auger housing 108) to permit snow to the rotatable auger 106. The inlet opening 160 may be defined in front of the rotatable auger 106, such as by a pair of side walls 108b and top wall 108a. When assembled, auger 106 may be mounted to frame 102 and disposed rearward from the inlet opening 160. Separately from or in addition to inlet opening 160, auger housing 108 may define an outlet opening 162 to permit snow to flow from rotatable auger 106 (e.g., as motivated by the same) and out of auger housing 108 through outlet opening 162. In some embodiments, outlet opening 162 is defined through top wall 108a. In turn, rotatable auger 106 may be mounted to frame 102 below outlet opening 162 to motivate snow therethrough.

Auger housing 108 can be in communication (e.g., fluid communication) with a chute or chute body 116. Moreover, the auger housing 108 can be connected with the chute 116 mechanically, electrically, or both. The chute 116 can extend, for example, above the auger housing 108. Optionally, chute 116 can include or be provided as a solid, nonpermeable body extending along the chute axis A_{C}, upward or downstream from outlet opening 162.

Whereas the chute 116 directs snow away from the auger 108 in an upward direction, the snow blower 100 may further include a scraper assembly 190 configured to scrape snow from the ground along a path cleared by the auger 108. The scraper assembly 190 may include a scraper bar configured to scrape the ground. The scraper bar can be coupled to the auger 106 or one or more wheels 114 of the snow blower 100. In some aspects, one or more springs (not shown) can be provided between the scraper bar and the auger 106 or wheel(s) 114 such that the scraper bar operates in a spring-loaded manner. For instance, the one or more springs may bias the scraper bar in a downward direction toward the ground relative to the auger housing 108 and the spring(s) may be compressed when the scraper bar contacts the ground along the path.

Turning now to FIGS. 3 through 6, various features of or adjacent to the battery compartment 112 of the snow blower 100 will be described in further detail. The battery compartment 112 has a compartment box or body 164 having a volume 166 and enclosed by a battery compartment cover 168. One or more battery packs 170 may be inserted in the volume 166. For instance, the compartment 112 may include a receiving well 172 forming a battery receiver 174 for each respective battery pack 170. As illustrated, the battery compartment 112 may include multiple (e.g., two or more, such as four) wells 172 spaced apart from each other and thus be configured to receive a corresponding number of battery packs 170 therein. It is noted the present disclosure contemplates the battery compartment 112 may be configured to receive any suitable number of battery packs 170 to power the snow blower 100. Each battery receiver 174 may include one or more electrical contacts provided in a battery terminal 200 disposed within the corresponding battery well 172. Generally, such contacts or battery terminal 200 are/is configured to electrically couple with a respective battery pack 170. In turn, each battery terminal 200 may be in selective electrical communication with the respective battery pack 170. Moreover, the electrical contacts or battery terminals 200 may be in electrical (e.g., wired) connection with a motor, controller, or any other electrically powered component of the snow blower 100 to provide power from the battery pack 170.

Generally, the battery compartment cover 168 may be opened and closed. In other words, the cover 168 may have an open position, in which a user is able to access the volume 166 of the battery compartment 112 (e.g., to insert or remove a battery pack 170) and a closed position, in which the volume 166 is enclosed and the batteries 170 are protected from the environment or in which access to the battery compartment 112 is otherwise restricted. The cover 168 may be pivotably or rotatably coupled to the battery compartment 112 or coupled in any other suitable manner. For instance, the cover 168 may be rotatably mounted to the frame 102 at a top body panel 252a (e.g., of a plurality of body panels 252) of the frame 102. In some embodiments, the cover 168 is pivotably coupled to the frame 102 as the battery compartment 112 is integral with the frame 102; however, the battery compartment 112 may optionally be separate from the frame 102 in other embodiments of the present disclosure, as will be described in detail below.

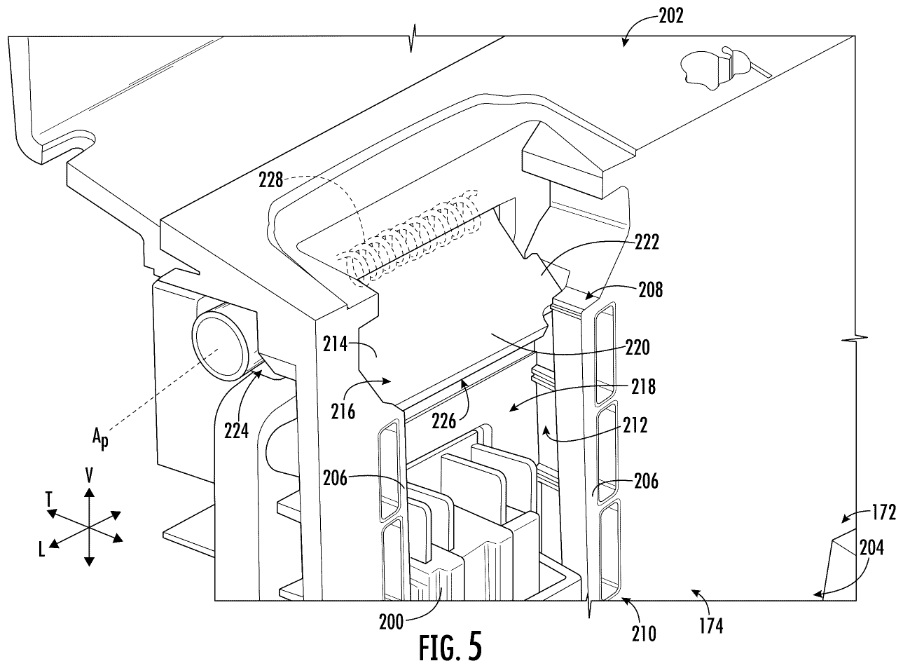

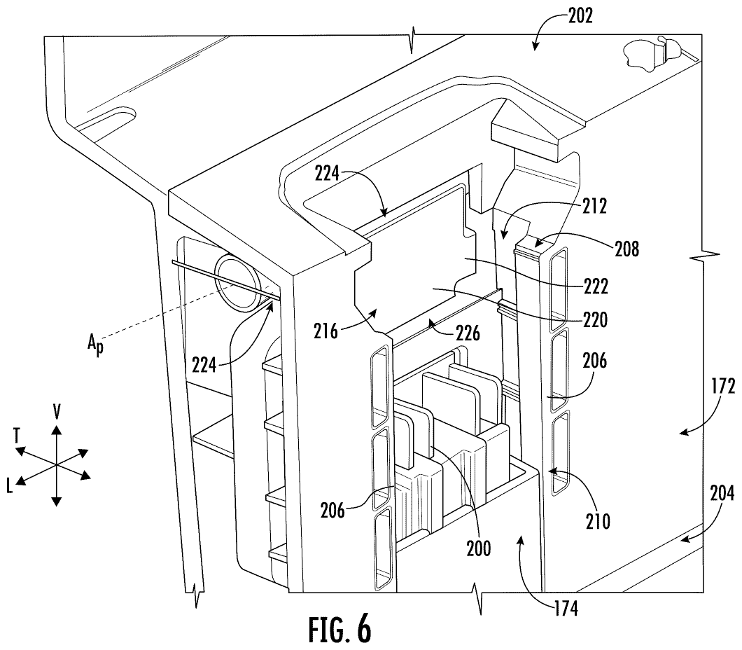

Turning especially to FIGS. 5 and 6, perspective views are provided of a portion of battery compartment 112. Specifically, a single battery well 172 and respective battery receiver 174 are illustrated according to exemplary embodiments of the present disclosure. Although a single battery receiver 174 is illustrated, it is noted multiple similar or identical receivers may further be provided (e.g., in separate or discrete corresponding wells), as would be understood in light of the present disclosure.

As noted above, a battery terminal 200 may be disposed within a battery well 172. In some embodiments, the battery well 172 extends vertically between a top well end 202 and a bottom well end 204. At the top well end 202, a well opening may be defined. The battery terminal 200, by contrast, may be disposed below well opening (e.g., at or proximate to bottom well end 204). A guide rail 206 may extend above battery terminal 200 (e.g., within the battery well 172 to or towards top well end 202). For instance, guide rail 206 may extend (e.g., vertically) between a top rail end 208 (e.g., at or proximal to top well end 202 or distal to bottom well end 204) and a bottom rail end 210 (e.g., at or proximal to bottom well end 204 or distal to top well end 202). Generally, guide rail 206 may serve to guide or partially restrain the movement or mounted position of the battery pack 170. In some such embodiments, guide rail 206 defines a vertical channel 212 (e.g., extending between the top rail end 208 and the bottom rail end 210) within which the battery pack 170 (i.e., a corresponding portion thereof) is slidably received. As shown, the vertical channel 212 may define an open space, such as a continuous horizontal (e.g., transverse) gap between a well wall and a bounding segment of guide rail 206.

It is noted that in optional embodiments, the guide rail 206 may be provided as or as part of a pair of guide rails 206. Thus, the guide rail 206 may include a pair of guide rails 206. As shown, the pair of guide rails 206 may be disposed on opposite horizontal (e.g., lateral) sides of battery terminal 200. Thus, battery terminal 200 may be horizontally (e.g., laterally) bounded by the pair of guide rails 206. Moreover, above the battery terminal 200 a rail (e.g., lateral) gap may be defined to receive a further portion of the battery pack 170.

Separate from or in addition to the guide rail 206, a deflector plate 214 may be provided in the battery receiver 174. As illustrated between FIGS. 5 and 6, deflector plate 214 may be movably mounted above the battery terminal 200 to move (e.g., pivot about a horizontal pivot axis Aₚ) between an obstructed position (FIG. 5) and an unobstructed position (FIG. 6), as will be described in greater detail below. Generally, the deflector plate 214 includes a solid, non-permeable primary body 220 configured to selectively cover at least a portion of the battery terminal 200.

During use, an upper surface 216 of the primary body 220 may be held above the battery terminal 200 and be disposed (e.g., selectively) directly above battery terminal 200. Moreover, when deflector plate 214 covers the battery terminal 200, the upper surface 216 may be directed upward (e.g., such that snow falls onto upper surface 216 instead of battery terminal 200). Optionally, the primary body 220 may be sized and shaped to complement or match the rail gap 218 and, thus, selectively fit within the rail gap 218 (e.g., between the pair of guide rails 206). In some embodiments, one or more side wings 222 may be sized and shaped to complement or match the vertical channel 212 and, thus, selectively fit within the same. For instance, a pair of side wings 222 may extend from opposite lateral sides of the primary body 220 to each be selectively received within a corresponding vertical channel 212.

In some embodiments, a deflector plate 214 is provided in biased engagement with deflector plate 214. For instance, a deflector spring 228 may be mounted above the battery terminal 200. Any suitable spring may be provided, such as a torsion spring, to urge rotation of the deflector plate 214 to or toward a set position, such as the obstructed position. Thus, the deflector spring 228 may bias the deflector plate 214 toward the obstructed position.

When assembled, the deflector plate 214 is generally held or located above the bottom rail end 210 (e.g., relative to the vertical direction V). As shown, the deflector plate 214 may be vertically spaced apart from the bottom rail end 210. Nonetheless, in some embodiments, the deflector plate 214 may also be held below at least a portion of the battery well 172 or guide rail 206. For instance, the deflector plate 214 may be located at a lower position relative to the vertical direction V than the top well end 202. Additionally or alternatively, the deflector plate 214 may be located at a lower position relative to the vertical direction V than the top rail end 208. Thus, relative to the vertical direction V, the deflector plate 214 may side between the top and bottom of the guide rail 206.

Turning now especially to FIG. 5, the deflector plate 214 is illustrated at an obstructed position according to exemplary embodiments. As shown, the obstructed position includes the deflector plate 214 extended across at least a portion of the guide rail 206. Specifically, at least a portion of the deflector plate 214 may be held directly above the battery terminal 200 (e.g., to intersect a vertical projection of the battery terminal 200). In turn, the deflector plate 214 may cover the battery terminal 200. In some embodiments, the primary body 220 continues radially outward from the horizontal pivot axis Aₚ defined by the deflector plate 214. The horizontal gap 218 (e.g., between the pair of guide rails 206) may be occupied by, for instance, the primary body 220 in the obstructed position. In particular, in the obstructed position, the deflector plate 214 (e.g., at or including the primary body 220) may extend from a rear portion of the horizontal gap 218 to a front portion of the horizontal gap 218. The one or more side wings 222 be held or received within a corresponding vertical channel 212 (e.g., further covering or blocking potential openings to the battery terminal 200) in the obstructed position. Notably, snow falling down toward the battery compartment 112 may be blocked from falling into the vertical channel 212 or on the battery terminal 200.

In certain embodiments, the deflector plate 214 is oriented at a sloped or slanted angle in the obstructed position. For instance, the upper surface 216 may be disposed at a non-orthogonal (e.g., non-vertical) angle θ relative to a horizontal direction or plane (i.e., direction or plane perpendicular to the vertical direction V). The non-orthogonal angle θ may be a negative or descending angle from a fixed or rear end 224 (e.g., at or proximal to the pivot axis Aₚ) to a free or forward end 226 (e.g., distal to the pivot axis Aₚ). In turn, the fixed or rear end 224 may be disposed at a higher location than a lower location of the free or forward end 226 relative to the vertical direction V. Nonetheless, as shown, the obstructed position may be non-parallel to the vertical channel 212 or vertical direction V. Snow or debris landing on the deflector plate 214 above the battery terminal 200 may, in turn, be directed (e.g., by gravity) along the upper surface 216 downward and forward apart from the battery terminal 200.

Turning now especially to FIG. 6, the deflector plate 214 is illustrated at an unobstructed position according to exemplary embodiments. As shown, the unobstructed position includes the deflector plate 214 horizontally spaced apart from the battery terminal 200. For instance, although being located at a higher relative location than the battery terminal 200, the deflector plate 214 may be horizontally offset from the battery terminal 200 or a vertical projection thereof. In turn, the battery terminal 200 may be uncovered. Moreover, the horizontal gap 218 may accommodate a portion of a battery pack 170 being coupled or connected to the battery terminal 200. For instance, the battery pack 170 may push the deflector plate 214 to the unobstructed position. Optionally, in the unobstructed position, the deflector plate 214 may be substantially parallel to the vertical channel 212. For instance, the deflector plate 214 may be directed downward and substantially parallel to the vertical channel 212. The side wings 222 may be held outside of the corresponding vertical channels 212.

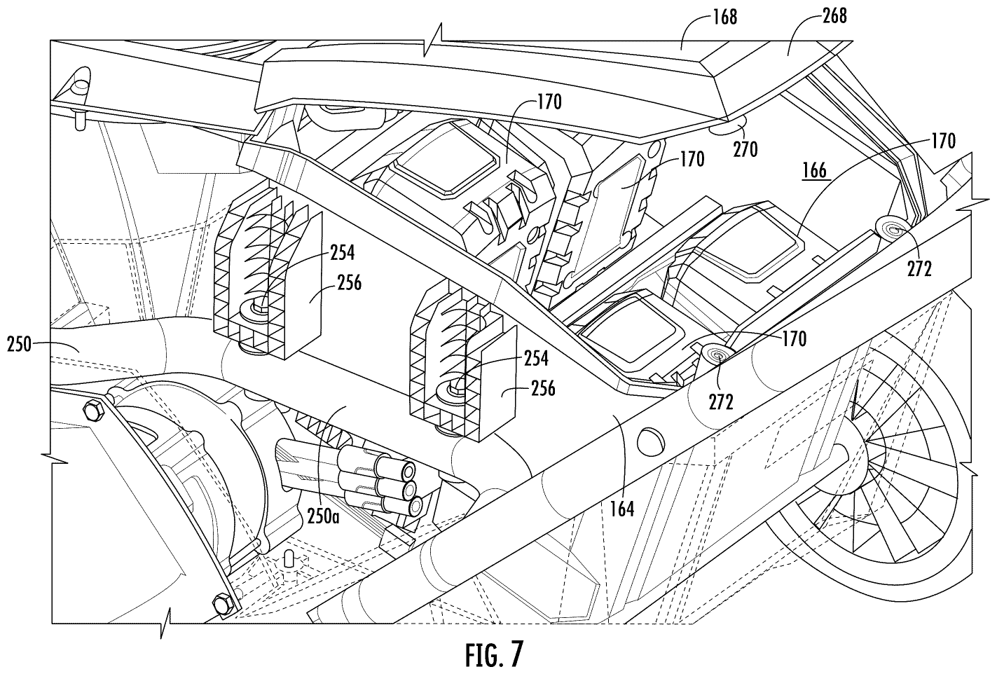

Turning now especially to FIGS. 7 through 10, the frame 102 may include a scaffolding base 250 and one or more body panels 252 attached to or supported on scaffolding base 250. Thus, scaffolding base 250 may form a skeletal structure onto which the one or more body panels 252 are attached (e.g., via one or more adhesives or mechanical fasteners, such as a screws, bolts, clips, welds, rivets, etc.).

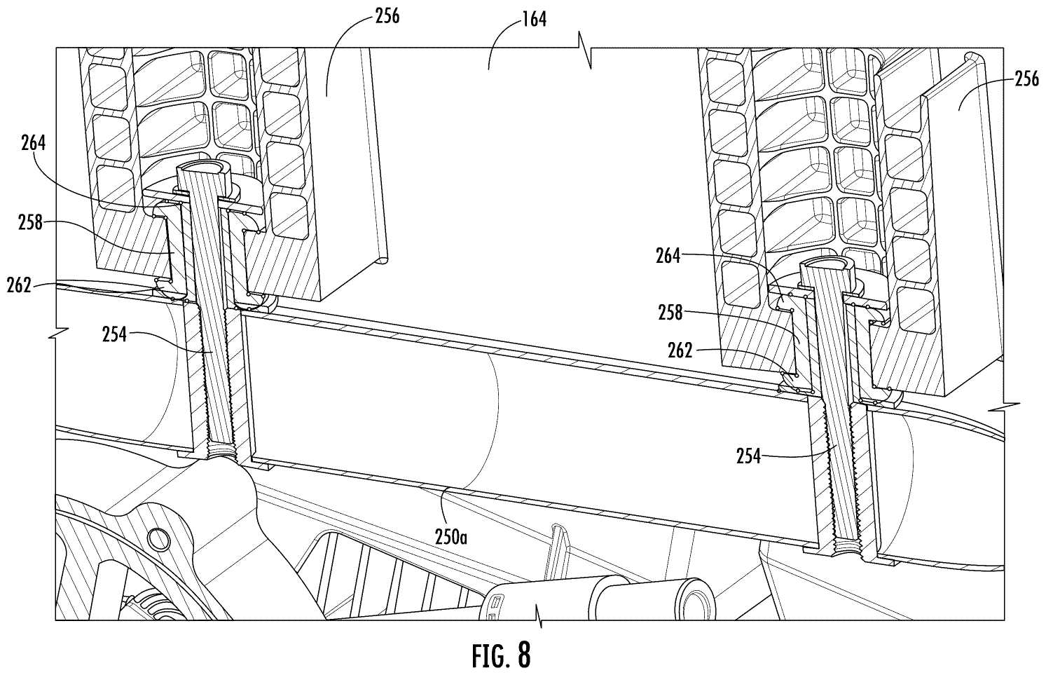

As noted above, battery compartment 112 includes a compartment box or body 164 that is attached to frame 102. In particular, the compartment box 164 may be attached to scaffolding base 250. In some embodiments, a plurality of mechanical fasteners 254 (e.g., screw and threaded sleeve corresponding to and receiving the screw) extending between the compartment box 164 and the scaffolding base 250 to secure the compartment box 164 to the scaffolding base 250. For instance, compartment box 164 may include or be formed with one or more mounting flanges 256 (e.g., extending horizontally outward opposite of the compartment volume 166) disposed or supported on one or more base rails 250a of the scaffolding base 250. Fastener holes may be defined through the mounting flange(s) 256 to receive the plurality of mechanical fasteners 254. In certain embodiments, a plurality of polymer (e.g., silicone or a natural or synthetic rubber) isolators 258 are provided on or between the plurality of mechanical fasteners 254. Specifically, the plurality of polymer isolators 258 may be disposed about the plurality of mechanical fasteners 254 between the mechanical fasteners 254 and the compartment box 164 to dampen vibrations from the scaffolding base 250 to the compartment box 164. As shown, especially in FIG. 8, each mechanical fastener 254 may have a discrete polymer isolator 258 disposed having an axial or longitudinal segment disposed about a portion of the longitudinal length of the mechanical fastener 254. As shown, the polymer isolator 258 may include a lower flange 262 extending radially outward and disposed (e.g., axially) between the mounting flange and the corresponding base rail 250a. Additionally or alternatively, the polymer isolator 258 may include an upper flange 264 extending radially outward and disposed (e.g., axially) between the mechanical fastener 254 (e.g., a head or washer thereof) and the mounting flange 256.

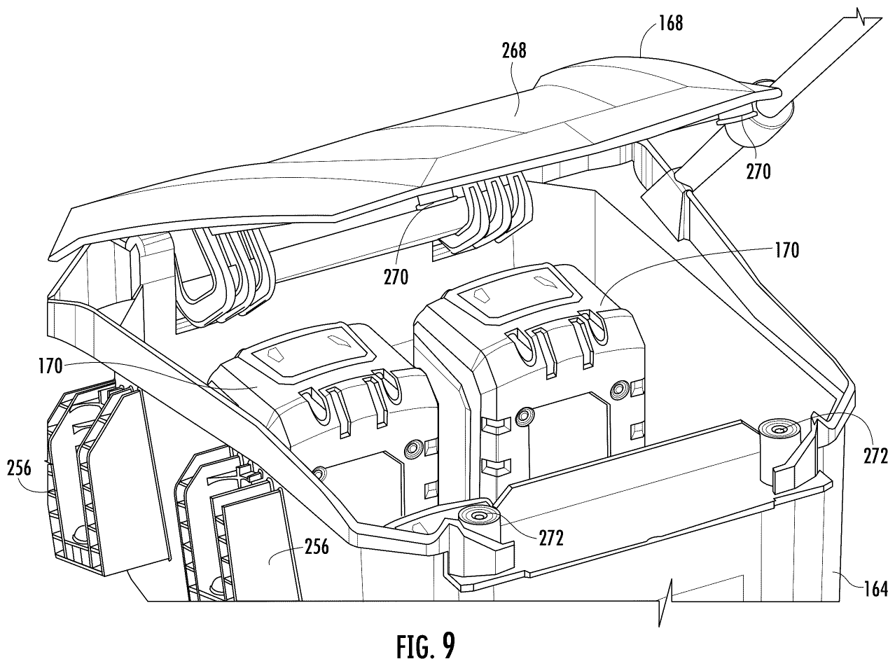

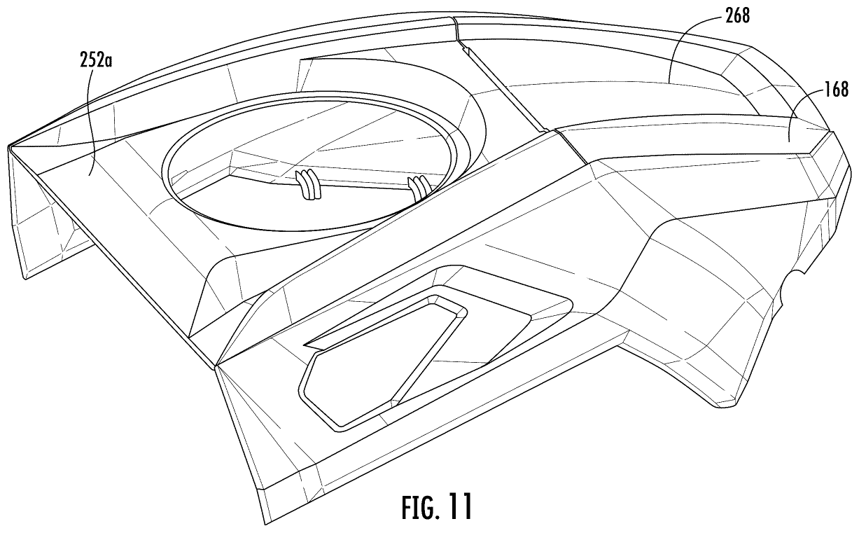

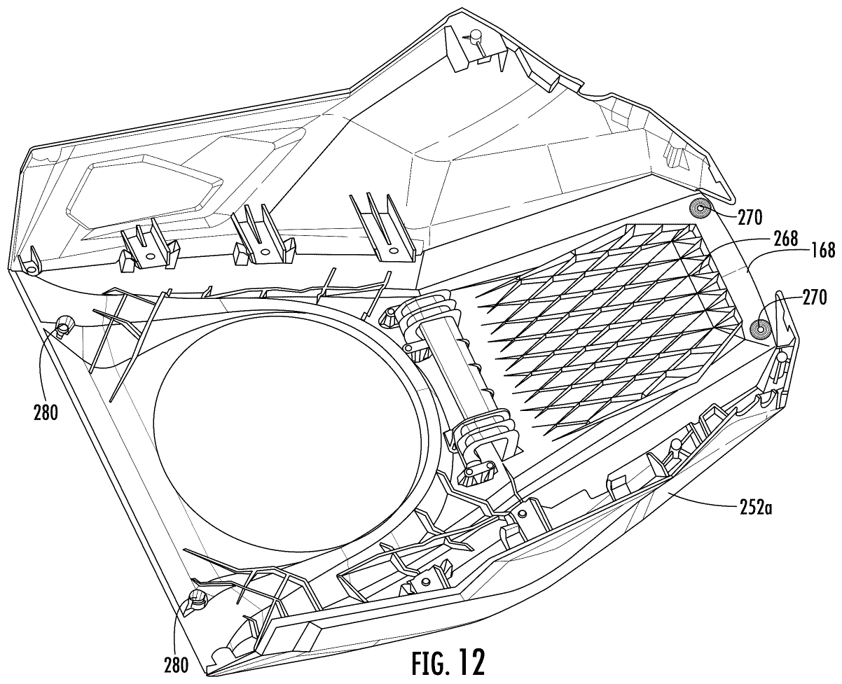

Turning now especially to FIGS. 9 through 12, the compartment cover 168 may be movably mounted to frame 102 to move between the open position and the closed position (e.g., as described above to permit access to the battery compartment 112 and restrict access to the battery compartment 112, respectively). As shown, compartment cover 168 may include a non-permeable door body 268 to block snow, moisture, or a user's hand from entering battery compartment 112 (e.g., in the closed position). When assembled, the door body 268 may be disposed above the battery compartment 112. In some embodiments, one or more primary magnetic elements 270 are mounted to the non-permeable door body 268. For instance, primary magnetic elements 270 may be fixed, embedded, or adhered to an inner facing surface of the door body 268 to magnetically engage with the frame 102 (e.g., at the closed position). In particular, a magnetic bond may be formed between the primary magnetic element 270 and a portion of the frame 102. Thus, the primary magnetic element 270 may bias the compartment cover 168 toward the closed position. In some such embodiments, one or more secondary magnetic elements 272 may be provided in or as part of the frame 102 to magnetically couple with the primary magnetic elements 270. As an example, the one or more secondary magnetic elements 272 may be fixed to one or more body panels 252 (e.g., a top body panel 252a) in selective matched engagement with the primary magnetic elements 270 in the closed position.

It is understood that the primary and secondary magnetic elements 270, 272 may be formed from any material that is suitably responsive to a magnetic field or capable of generating a magnetic field. In other words, the primary and secondary magnetic elements 270, 272 are not formed from a purely diamagnetic material. The primary and secondary magnetic elements 270, 272 may be formed from the same material or unique materials. As an example, the primary magnetic element 270 may be one of a permanent magnet, ferromagnetic body, or electromagnetic element while the secondary magnetic element 272 is another of a permanent magnet, ferromagnetic body, or electromagnetic element. As another example, the primary magnetic element 270 may be one of a permanent magnet, ferromagnetic body, or electromagnetic element while the secondary magnetic element 272 is the same of a permanent magnet, ferromagnetic body, or electromagnetic element.

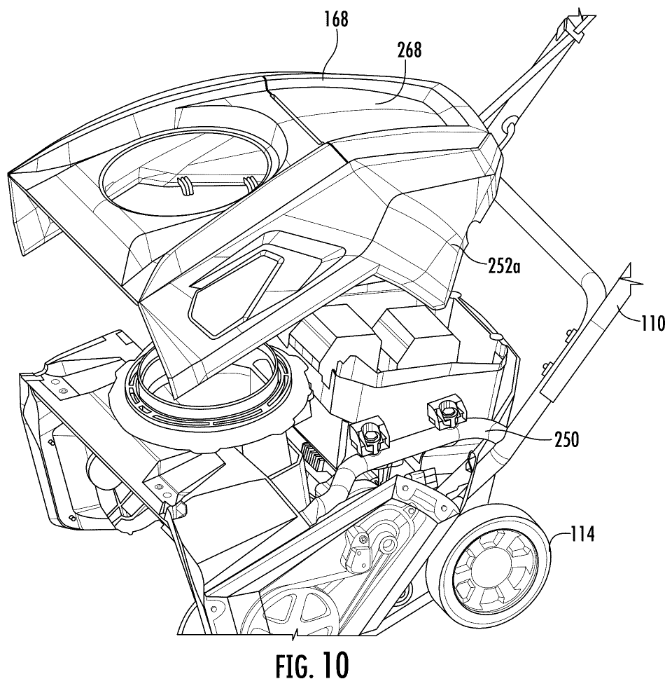

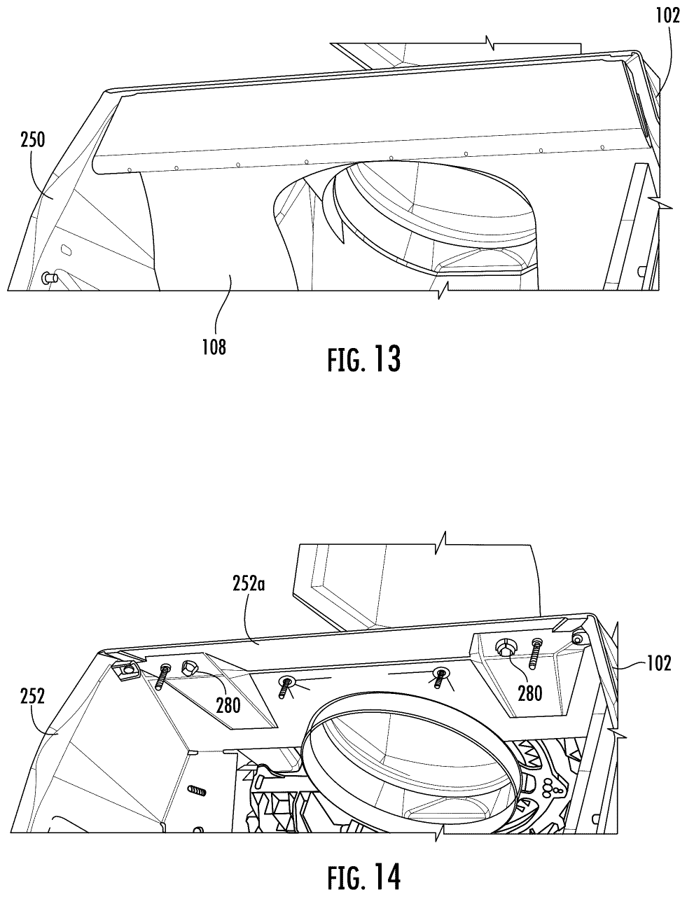

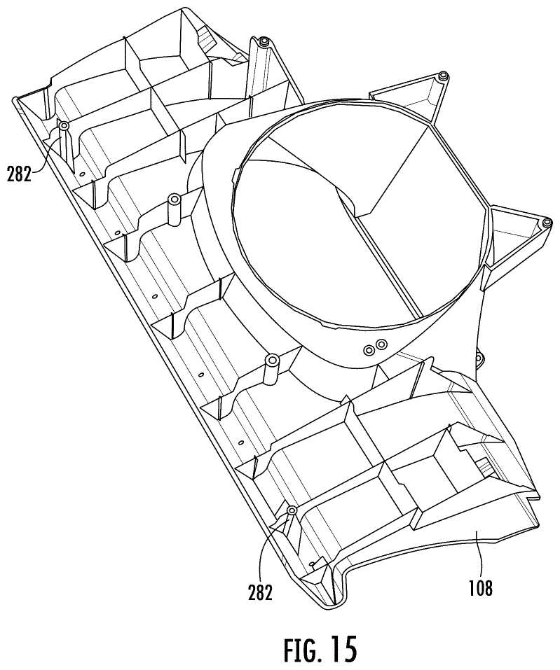

Turning now especially to FIGS. 10 through 15, and as noted above, compartment cover 168 may be mounted to the frame 102 at the top body panel 252a. As shown, the top body panel 252a may be disposed above (e.g., directly above or at a higher vertical position relative to) the battery compartment 112 or rotatable auger 106. When assembled, the top body panel 252a may similarly hold the compartment cover 168 above the battery compartment 112 or rotatable auger 106) as the compartment cover 168 pivots or rotates (e.g., along a pivot path extending above top body panel 252a). In some embodiments, the compartment cover 168 and top body panel 252a are provided as a single pre-assembled unit. For instance, the compartment cover 168 may be rotatably fixed to the top body panel 252a (e.g., rotatable relative to the top body panel 252a and fixed to the top body panel 252a). The top body panel 252a itself may be attached to the scaffolding base 250. Thus, as the top body panel 252a is moved or assembled relative to the scaffolding base 250, so too may be the compartment cover 168. Moreover, the compartment cover 168 may be attached to the scaffolding base 250 through the top body panel 252a.

In optional embodiments, one or more other components may be attached to the frame 102 or scaffolding base 250 through the top body panel 252a. For instance, at least a portion of the auger housing 108 (e.g., disposed about the chute or above the rotatable auger 106) may be secured to the top body panel 252a. In some such embodiments, one or more snap-fit tabs 280 are provided between the top body panel 252a and the auger housing 108. For instance, the snap-fit tabs 280 may be fixed to a bottom-facing surface of the top body panel 252a to selectively snap or clip to (e.g., in friction-fit engagement with) a corresponding mating surface or tab 282 on an upward-facing surface of auger housing 108.

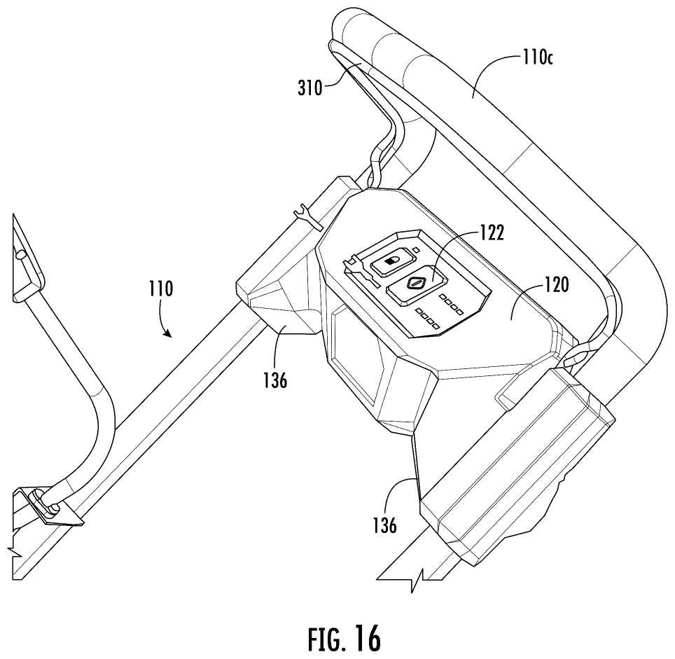

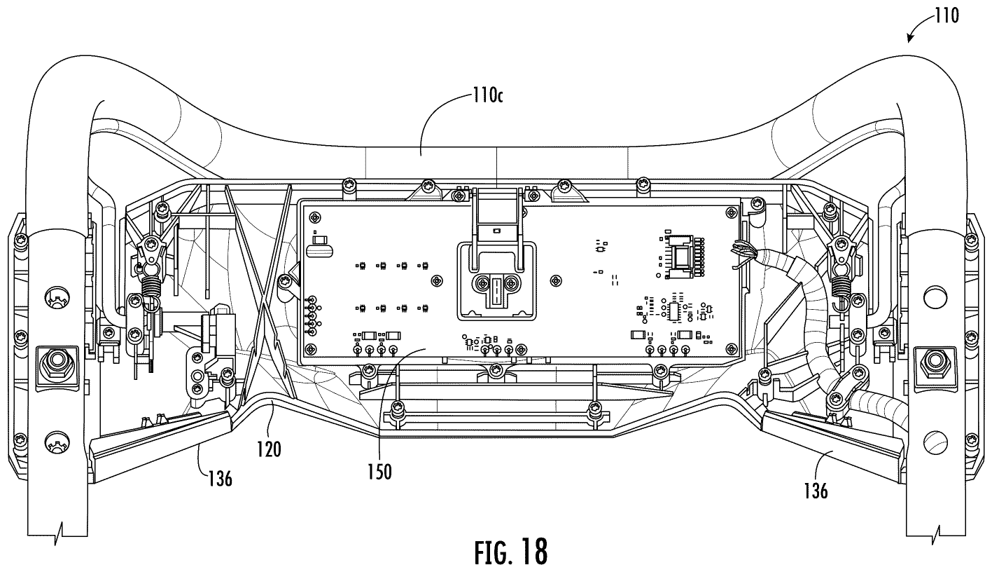

Turning now generally to FIGS. 16 through 22, a control panel 120 may be included with snow blower 100. Specifically, handle assembly 110 may include a control panel 120. Generally, control panel 120 is disposed or held above the frame 102 and wheels 114. In the illustrated embodiments, control panel 120 extends (e.g., laterally) between the two handle 110a, 110b. The control panel 120 generally include one or more controls associated with controlling operational aspect(s) of the snow thrower 100. By way of non-limiting example, the control panel 120 can include a power or start input 122 (e.g., button) or other input (e.g., light-unit activation input, such as a separate button) in operable communication, for instance, a controller 150 (e.g., mounted on or within snow blower 100).

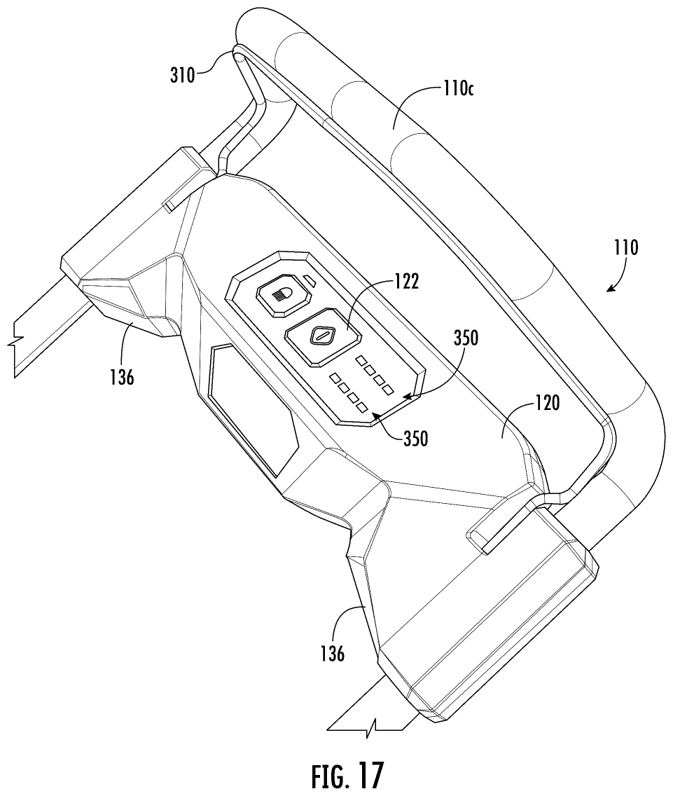

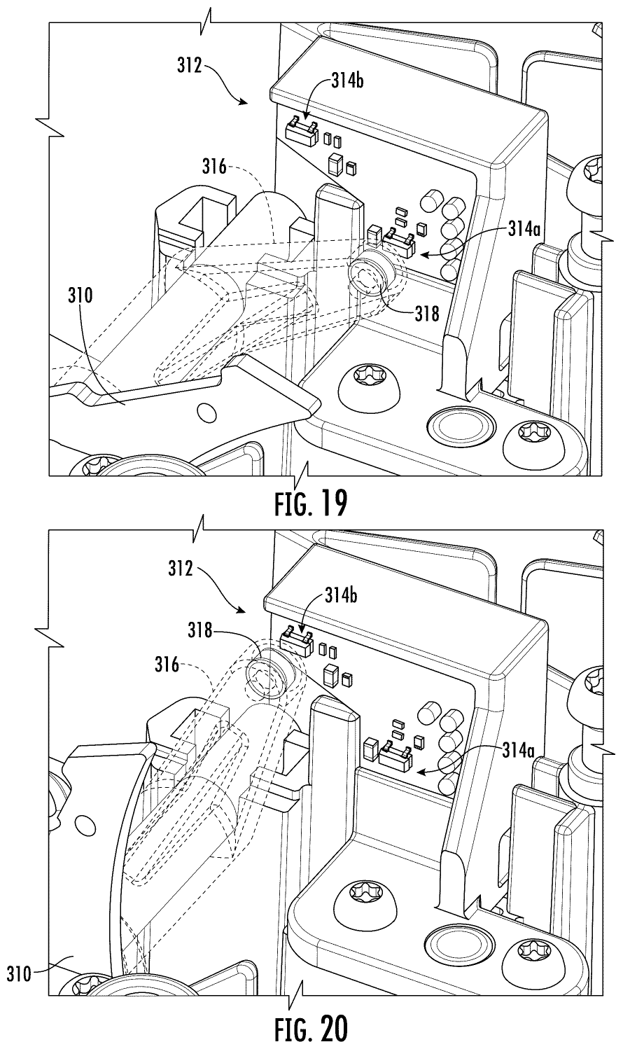

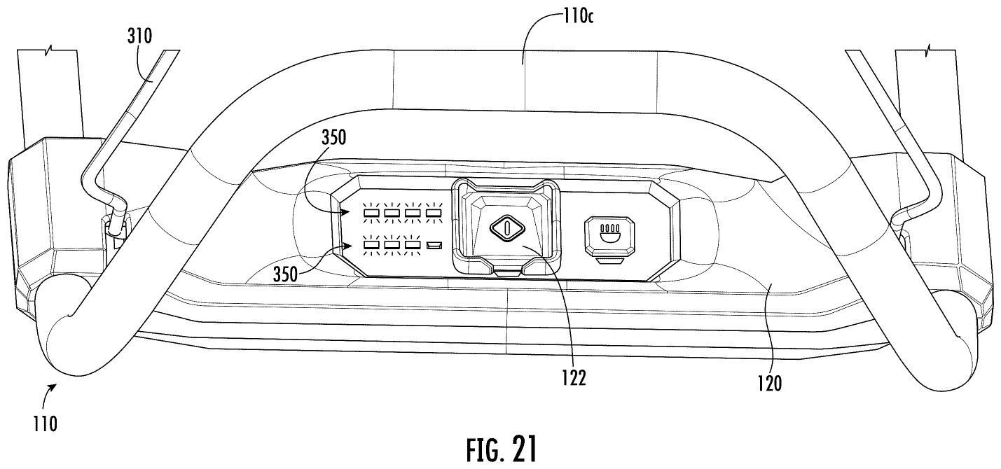

Separate from or in addition to control panel 120, a bail control bar 310 may be movably attached to the handle assembly 110 apart from the frame 102. Generally, bail control bar 310 is movable between a released position (e.g., FIGS. 20 and 21) and an engaged position (e.g., FIGS. 17 and 19). In some embodiments, the bail control bar 310 may fit within a recessed portion of the top handle 110c when in the engaged position, thereby allowing the bail control bar 310 to be substantially flush with the top handle 110c during operation of the snow blower 100. Optionally, the bail control bar 310 may be spring-biased towards the released position, thereby requiring a user to grip the bail control bar 310 to maintain the bail control bar 310 in the released position.

In some embodiments, bail control bar 310 is in operable communication with the rotatable auger 106 (e.g., via controller 150 as a failsafe device). For instance, during use, a user may be required maintain the bail control bar 310 in the engaged position in order to initiate operation of motor 110a or 110b. Furthermore, upon release of the bail control bar 310 causing the bail control bar 310 to transition to the released position, the controller 150 will stop operation of the motor 110a or 110b, as will be described in more detail below.

As noted above, the bail control bar 310 is configured to prevent operation of the motor 104a or 104b in response to the bail control bar 310 being in the released position. In particular, the released position may restrict activation of the rotatable auger 106 (e.g., or motor 104a thereof) and the engaged position may permit activation of the rotatable auger 106 (e.g., or motor 104a thereof). A sensor array 312 including one or more electric field (e.g., Hall effect) sensors may provide an indication of the position of the bail control bar 310 to the controller 150. In optional embodiments, at least a portion of the bail control bar 310 and the sensor array 312 are contained in the control panel 120 of the snow blower 100.

In some embodiments, a bar linkage 316 is fixed to the bail control bar 310 to move therewith while a permanent magnet 318 is mounted or fixed on the bar linkage 316 to move between the released position and the engaged position with the bail control bar 310. A first hall effect sensor 314a of the sensor array 312 may be fixed within the control panel 120 in selective alignment with the permanent magnet 318 (e.g., at the engaged position). Thus, position of the bail control bar 310 will place the permanent magnet 318 in relative proximity to or alignment with the first hall effect sensor 314a when the bail control bar 310 is in an engaged position. The permanent magnet 318 is moved away from and out of range of the first hall effect sensor 314a when the bail control bar 310 is in a released position. Optionally, a second hall effect sensor 314b of the sensor array 312 may be fixed within the control panel 120 apart from the first hall effect sensor 314a in selective alignment with the permanent magnet 318 (e.g., at the released position). Thus, position of the bail control bar 310 will place the permanent magnet 318 in relative proximity to or alignment with the second hall effect sensor 314b when the bail control bar 310 is in a released position.

The sensor array 312 may be in operable (e.g., electrical or wireless) communication with the controller 150. During use, the positioning of the permanent magnet 318 generates a magnetic field which is detectable by the first or second hall effect sensor 314a or 314b. Depending on the strength of the magnetic field detected by either the first or second hall effect sensor 314a or 314b, which in turn correlates to the position of the permanent magnet 318 and vis-à-vis the bail control bar 310, the first or second hall effect sensor 314a or 314b may output a signal to the controller 150 indicating whether the bail control bar 310 is in a released position or an engaged position.

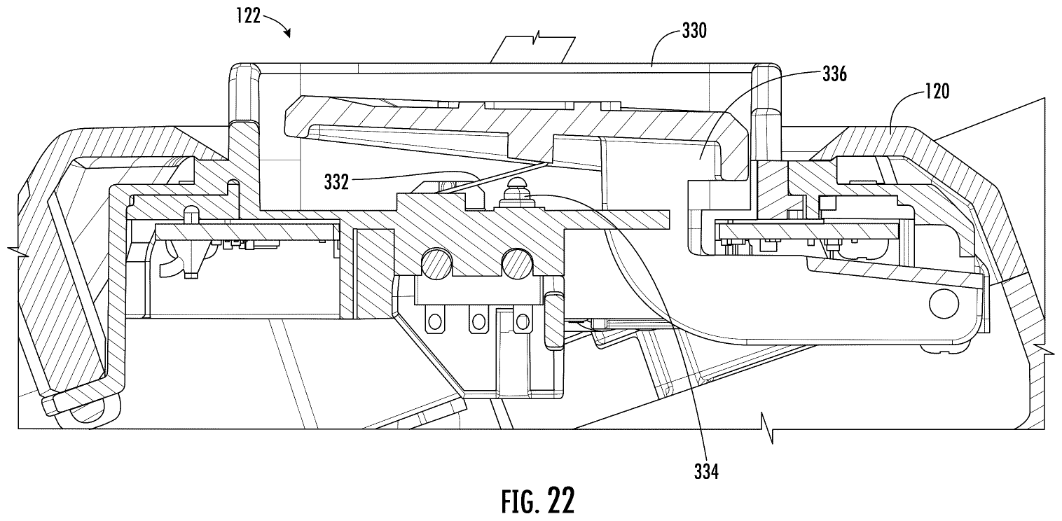

In some embodiments, activation of the rotatable auger 106 (e.g., the motor 104a thereof) may require engaging the start input 122. As shown in FIG. 22, The start input 122 may include a pivotable lever body 336 rotatably mounted on control panel 120. An optional button membrane 330 may be disposed over pivotably lever body 336. A button spring 332 may be disposed on (e.g., below) lever body 336 and bias lever body 336 upward (e.g., away from a microswitch 334 in operable communication with the controller 150). In turn, pressing against the lever body 336 (e.g., through the button membrane 330) may drive the lever body 336 downward and into engagement with the microswitch 334 such that a signal is transmitted to the controller 150, thereby permitting controller 150 to register an auger control or start command.

In certain embodiments, the controller 150 is configured to control an operation of the rotatable auger 106, such as to activate the motor 104a to drive rotation of the rotatable auger 106 based on both the start input 122 and the bail control bar 310. In some such embodiments, the controller 150 is configured to receive an auger control command (e.g., in response to a user engaging the start input 122). The controller 150 may also be configured to determine the bail control bar 310 is in the engaged position based on the sensor array 312 (e.g., as described above). The controller 150 may further be configured to control, in response to determining that the bail control bar 310 is in the engaged position, the rotatable auger 106 based on the received auger control command. Optionally, the controller 150 may still further be configured to determine the bail control bar 310 is in the released position based on the sensor array 312 and halt the rotatable auger 106 in response to determining that the bail control bar 310 is in the released position. Thus, the motor 104a may be deactivated in response to user releasing the bail control bar 310.

Turning especially to FIG. 21, one or more battery meters 350 may be provided on control panel 120. Generally, each battery meter 350 may be in operable communication with the mounted battery packs 170 (e.g., via controller 150) and configured to display or otherwise present a visual representation of a discrete battery pack. For instance, the illumination of a particular battery meter 350 may correspond to a particular battery receiver and battery pack connected to the same. In particular, the illumination may correspond to or be correlated with the relative charge or power capacity (e.g., as a level, percentage, or fraction of the total charge capacity) of a connected battery pack). Multiple battery meters 350 may be provided, each battery meter 350 corresponding to a discrete battery receiver 174 and battery pack 170. Thus, each battery meter 350 may provide a separate and independent display of the relative capacity for each battery pack. In some such embodiments, for each battery meter 350, the controller 150 is configured to determine a power capacity of the battery pack, and direct illumination of the battery meter 350 according to the determined power capacity of the battery pack. Optionally, the battery meter 350 may include a plurality of discrete light emitting diodes. In some such embodiments, direct illumination of the battery meter 350 includes determining a number of light emitting diodes of the plurality of light emitting diodes to illuminate according to the determined power capacity. Thus, the number of activated or illuminated LEDs of the battery meter 350 may correspond to the determined power capacity.

As shown, multiple battery meters 350 may be provided for multiple different battery packs. It is noted that although two battery meters 350 are shown, any suitable number of meters (e.g., corresponding to the provided number of battery receivers 174 within the battery compartment 112) may be provided.

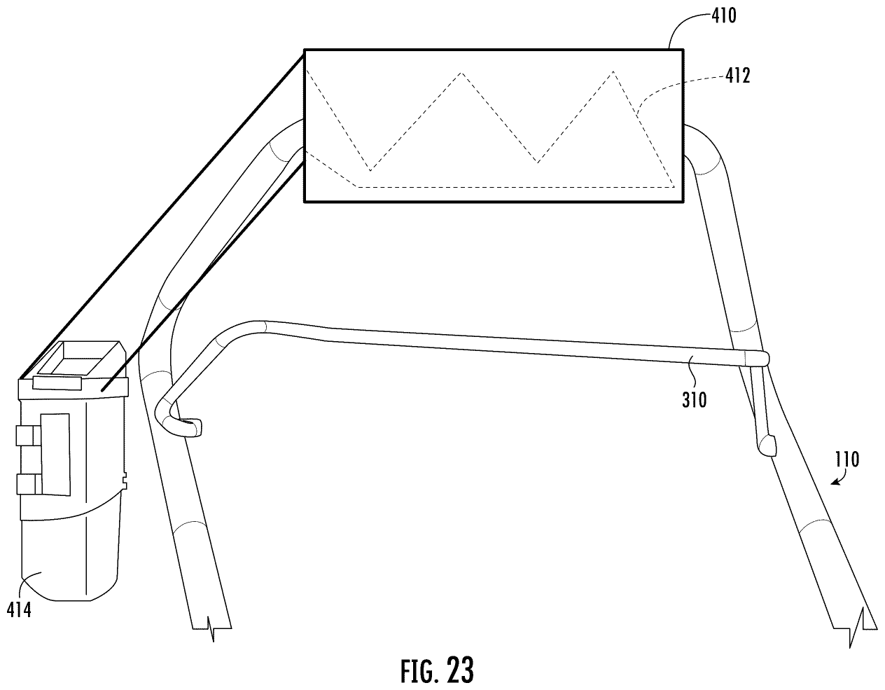

Turning especially to FIG. 23, in some embodiments, a removable hand warmer 400 device is provided. Generally, the hand warmer 400 may be selectively placed on or removed from the snow blower (e.g., at the handle assembly 110 or top handle 110c) to generate heat for warming a user's hands on the snow blower 100. The hand warmer 400 may include, for instance, a fabric substrate 410 having one or more fasteners (e.g., snaps, buttons, clips, hook and loop fasteners, etc.) for holding the fabric substrate 410 on itself. Thus, the fabric substrate 410 may be wrapped onto a portion of the handle assembly 110. Fixed to the fabric substrate 410 may be a resistive heating element 412 configured to generate heat in response to an electrical current directed through the heating element. Optionally, an element battery (e.g., held apart from the frame, independent of the battery packs 170) may be provided in electrical communication with the resistive heating element 412 to power the same.

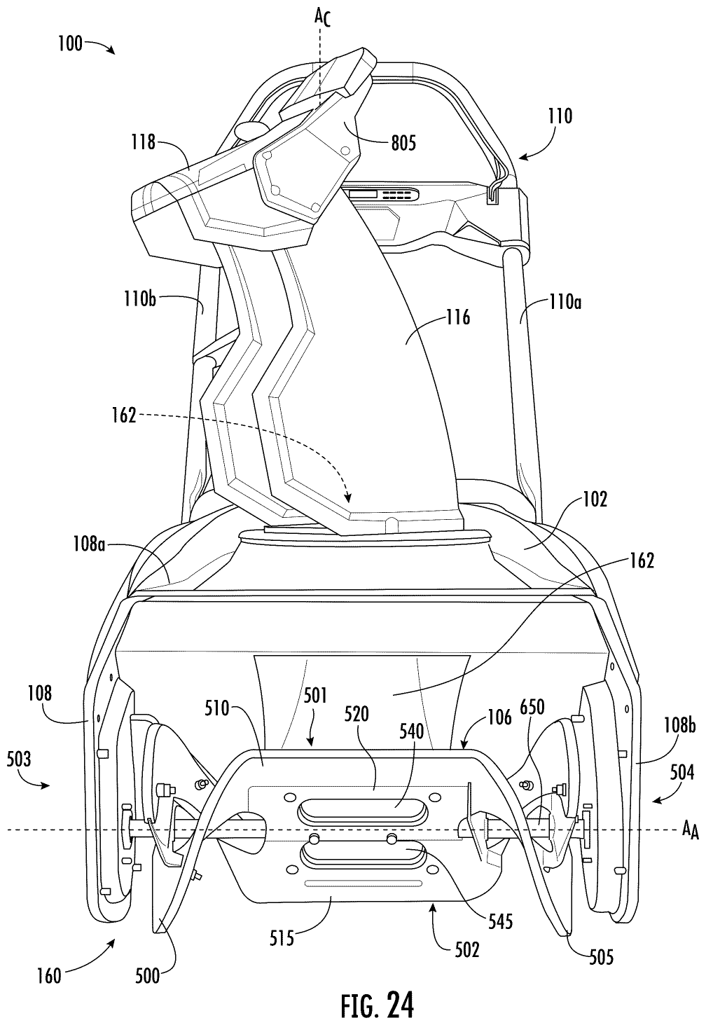

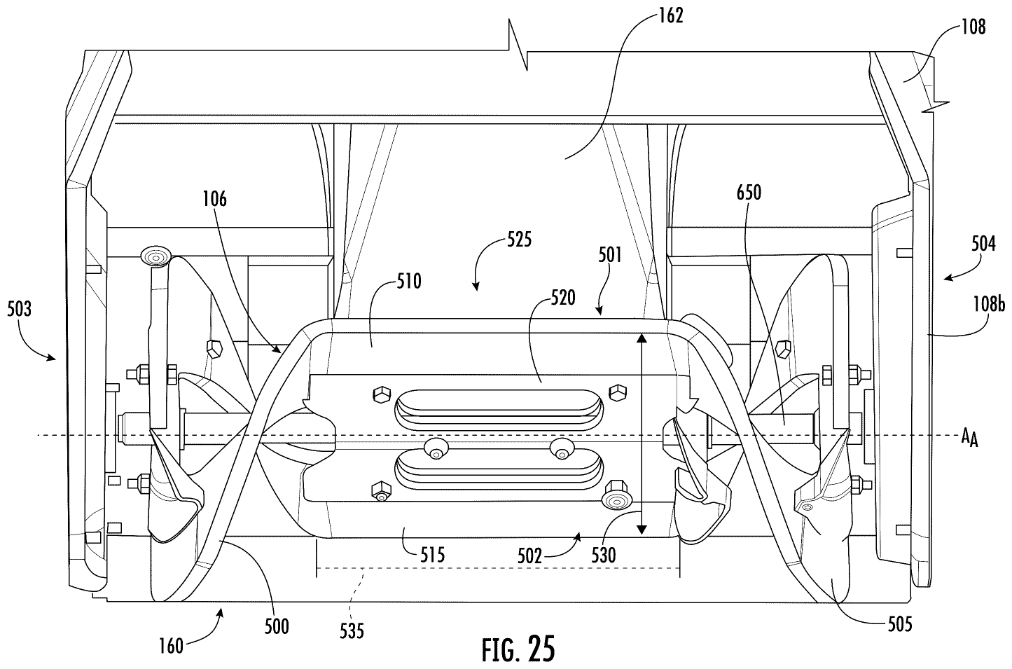

Turning now to FIGS. 24 through 30, various features of or adjacent to the auger 106 and the auger housing 108 will be described in further detail. With reference to FIGS. 24 and 25, the auger 106 may include one or more auger segments. For example, the auger 106 may include a first auger segment 500, a second auger segment 505, a first auger bracket 510, a second auger bracket 515, and a center auger portion 520. One or more of the auger segments, such as the first auger segment 500, the second auger segment 505, the first auger bracket 510, the second auger bracket 515, and the center auger portion 520 may be separate, discrete components. In other example embodiments, one or more of the first auger segment 500, the second auger segment 505, the first auger bracket 510, the second auger bracket 515, and the center auger portion 520 may be integral components.

The first auger bracket 510, the second auger bracket 515, and the center auger portion 520 may define a central auger section, such as a primary auger section 525, between the first auger segment 500 and the second auger segment 505. In some example embodiments, the primary auger section 525 of the auger 106 may be substantially flat. Such a substantially flat shape creates less flow interruption, which may increase a throw distance of the snow from the snow blower 100.

With reference to FIG. 25, the primary auger section 525 includes an auger width 530 extending perpendicular to the auger axis A_{A} between a first side 501 and a second side 502 of the auger 106 and an auger length 535 extending parallel to the auger axis AA between a first end 503 and a second end 504 of the auger 106. In at least one example embodiment, the auger length 535 may be greater than or equal to about 150 mm and less than or equal to about 250 mm. For example, the auger length 535 may be about 200 mm. Additionally, the auger width 530 may be greater than or equal to about 50 mm and less than or equal to about 150 mm in some example embodiments. For example, the auger width 530 may be about 100 mm.

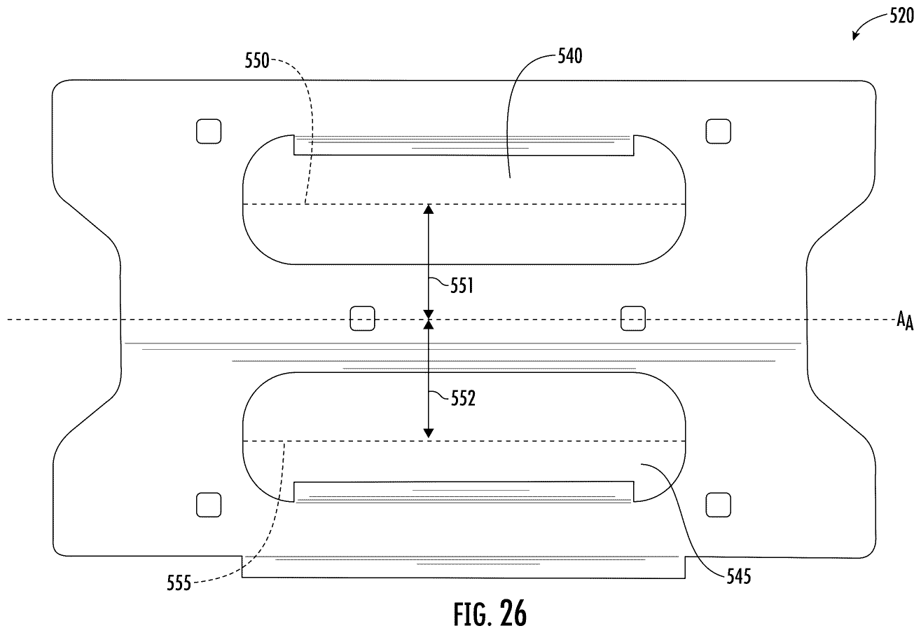

Turning to FIG. 26, the auger 106 defines one or more openings. For example, the auger 106 may define a first opening 540 and a second opening 545. The first opening 540 and the second opening 545 may be disposed in the primary auger section 525 and, more particularly, may be disposed in the center auger portion 520. The first opening 540 may be adjacent a first side of the auger axis A_{A} and the second opening 545 may be adjacent a second side of the auger axis A_{A} opposite the first side. More specifically, the first opening 540 and the second opening 545 may be on opposing sides of the auger axis A_{A}. Positioning the first opening 540 and the second opening 545 in the primary auger section 525, such that the first opening 540 and the second opening 545 are in a central portion of the auger 106, permits outer, solid portions of the auger 106 to throw the fastest velocity snow particles through the outlet opening 162 and into the chute 116, which may increase a throw distance of the snow from the snow blower 100.

The auger 106 includes an opening area defined by a first area of the first opening 540 and a second area of the second opening 545. Moreover, an auger area is defined by the auger width 530 and the auger length 535, shown in FIG. 25. In at least one example embodiment, a ratio of the opening area to the auger area is about 82%.

Additionally, the first opening 540 defines a first opening axis 550 and the second opening defines a second opening axis 555. The first opening axis 550 and the second opening axis 555 extend through a center of the first opening 540 and the second opening 545, respectively, and are parallel with the auger axis A_{A}. The first opening axis 550 and the second opening axis may be spaced from the auger axis A_{A} to define a first opening distance 551 between the first opening 540 and the auger axis A_{A} and a second opening distance 552 between the second opening 545 and the auger axis A_{A}. The first opening distance 551 and the second opening distance 552 may be a center-to-center distance such that the first opening distance is defined between the auger axis A_{A} and the first opening axis 550 and the second opening distance 552 is defined between the auger axis A_{A} and the second opening axis 555. In at least one example embodiment, the first opening distance 551 and the second opening distance 552 are substantially equal. For example, the first opening distance 551 and the second opening distance 552 may be less than or equal to about one-fourth of the auger width 530. In other example embodiments, the first opening distance 551 and the second opening distance 552 may be different.

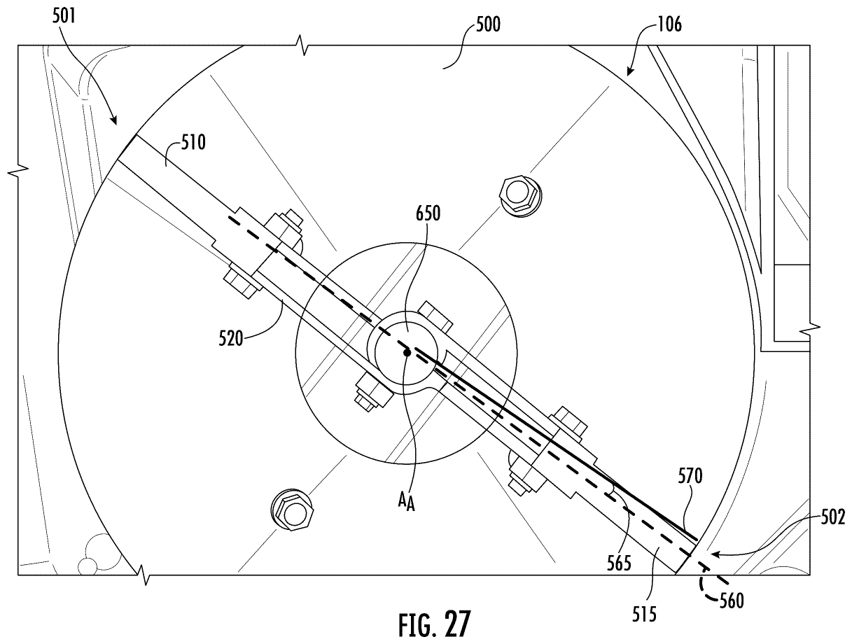

Turning to FIG. 27, the auger 106 includes a radial axis 560 extending perpendicular to the auger axis A_{A}. The auger 106 may define a rake angle 565 between the radial axis and an auger line 570 extending radially from the auger axis AA to an end, such as the first side 501 and the second side 502 of the primary auger section 525. In at least one example embodiment, the rake angle 565 is greater than 0°. The rake angle 565 may increase the contact time the auger 106 makes with snow, which may increase a throw distance of the snow from the snow blower 100.

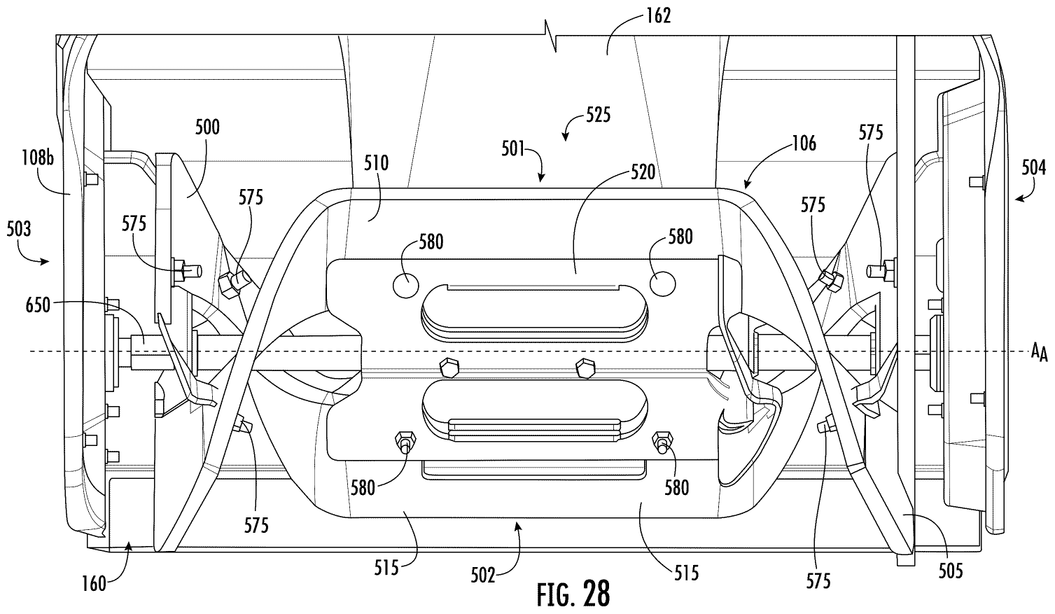

Turning to FIG. 28, the auger 106 may be secured within the auger housing 108 by a plurality of fasteners. For example, a first plurality of fasteners 575 may secure the auger 106 in the auger housing 108 via the first auger segment 500 and the second auger segment 505. For example, the first plurality of fasteners 575 may secure the first auger segment 500 and the second auger segment 505 to the side walls 108b of the frame 102. In at least one example embodiment, the first plurality of fasteners 575 may include one or more bolts or screws for securing the rotatable auger to the side walls 108b of the frame 102. More particularly, one or more of the first plurality of fasteners 575 may include carriage bolts.

Additionally, the center auger portion 520 may be removably coupled to the auger 106. For example, the center auger portion 520 may be removably coupled to the first auger bracket 510 and the second auger bracket 515. In such embodiments, a second plurality of fasteners 580 may secure the center auger portion 520 to the first auger bracket 510 and the second auger bracket 515. The second plurality of fasteners 580 may be similar or analogous to the first plurality of fasteners 575. For example, one or more of the second plurality of fasteners may include bolts, screws, carriage bolts, or a combination thereof.

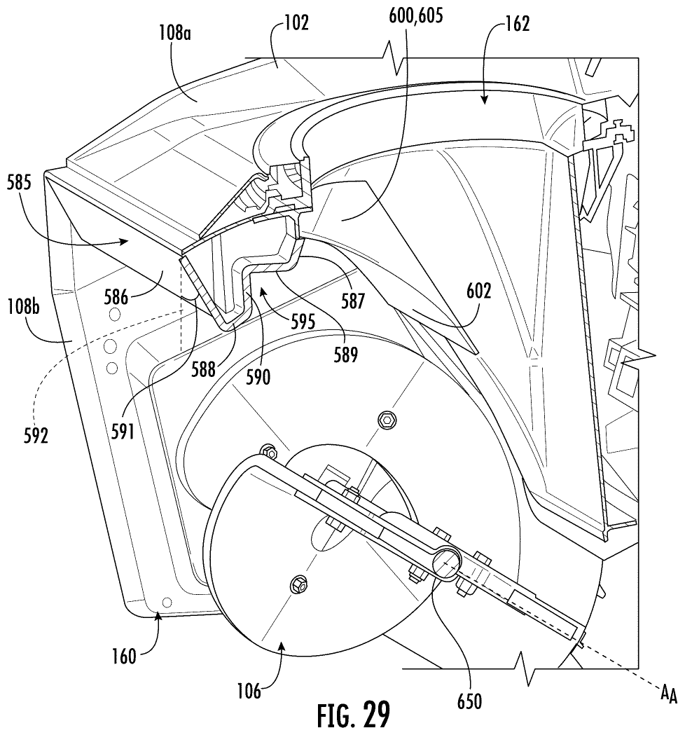

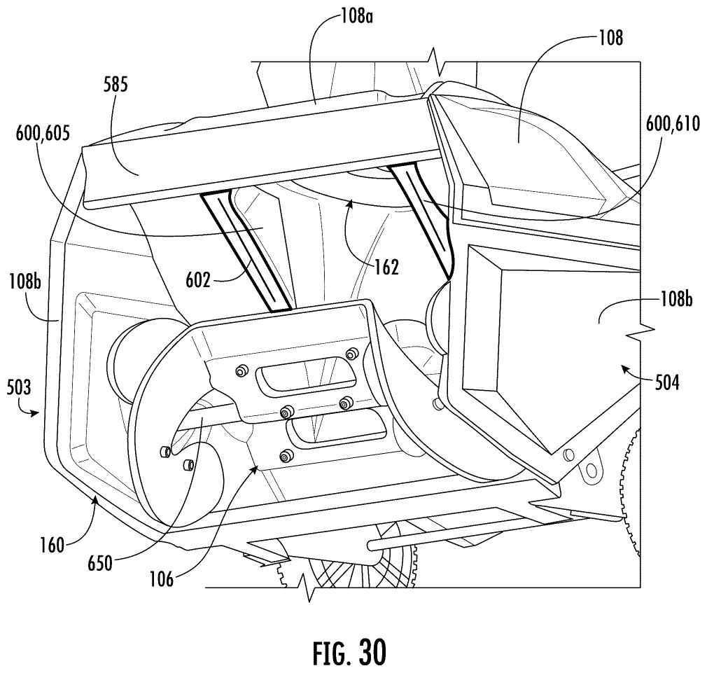

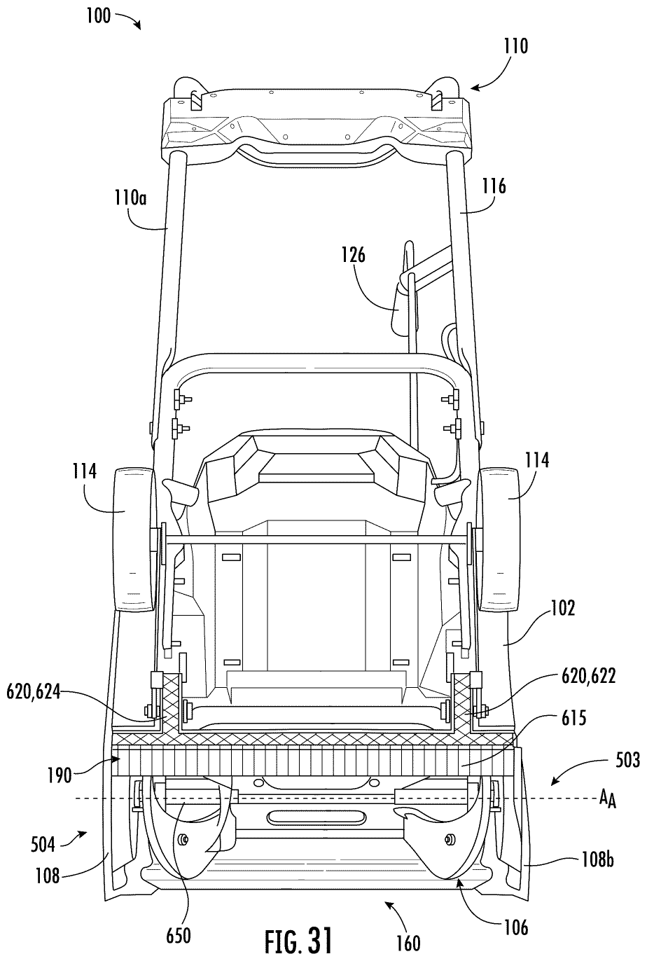

Turning now to FIGS. 29 through 30, the frame 102 of the snow blower 100 may include a guard 585. The guard 585 may at least partially extend into the auger housing 108 from an interior surface of the top wall 108a. Additionally, the guard 585 may be positioned adjacent the inlet opening 160 and extend along the auger axis AA between the side walls 108b.

In at least one example embodiment, the guard 585 defines an exterior wall 586 and an interior wall 587 opposite the exterior wall and facing the interior of the auger housing 108. The exterior wall 586 may extend at a wall angle 591 relative to a vertical axis 592 extending through the top wall 108a of the auger housing 108 adjacent the inlet opening 160. For example, the wall angle 591 may be less than 90°. In other example embodiments, the exterior wall 586 may extend parallel with the vertical axis 592.

In some example embodiments, a length of the exterior wall 586 may be greater than a length of the interior wall 587. The guard 585 may also include a first lower wall 588 extending from the exterior wall, a second lower wall 589 extending from the interior wall 587, and an intermediate wall 590 extending between the first lower wall 588 and the second lower wall 589. The first lower wall 588 and the second lower wall 589 may extend substantially perpendicular to the exterior wall 586, the interior wall 587, and the intermediate wall 590. Additionally, the second lower wall 589 and the intermediate wall 590 may form about a 90° angle. Moreover, the guard 585 defines a recess 595 between the second lower wall 589 and the intermediate wall 590.

In at least one example embodiment, the guard 585 may be configured to prevent snow from being thrown out of the auger housing 108 via the inlet opening 160. Additionally, or alternatively, the guard 585 may provide a hand grip for an operator of the snow blower 100.

In some example embodiments, at least on baffle 600 is disposed in the auger housing 108 of the snow blower 100. For example, the at least one baffle 600 may be disposed within the auger housing 108 adjacent the outlet opening 162. Moreover, the at least one baffle 600 may define at least a portion of the outlet opening 162. For example, the at least one baffle 600 may include a first baffle 605 and a second baffle 610 disposed on opposing sides of the outlet opening 162. More specifically, the first baffle 605 may be disposed adjacent the first end 503 and the second baffle 610 may be disposed adjacent the second end 504. The at least one baffle 600 is configured to prevent at least a portion of snow from being thrown into the chute 116 via the outlet opening 162.

The at least one baffle 600 includes an outer surface 602 facing the interior of the auger housing 108. For example, the outer surface 602 faced the auger 106. In at least one example embodiment, the outer surface 602 of the at least one baffle 600 may be curved, as shown in FIG. 29. In other example embodiments, the outer surface 602 of the at least one baffle 600 may be linear or planar, as shown in FIG. 30.

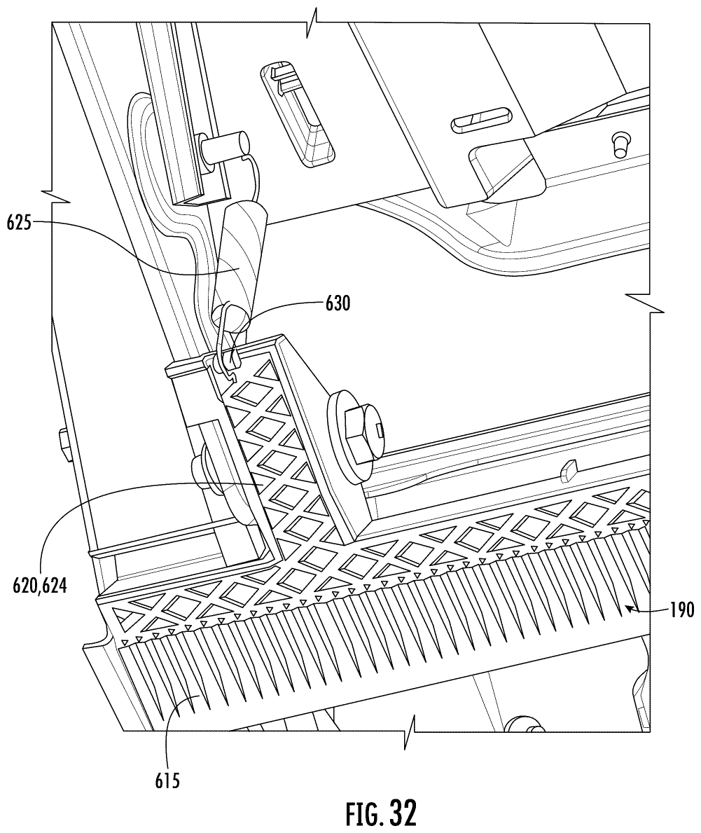

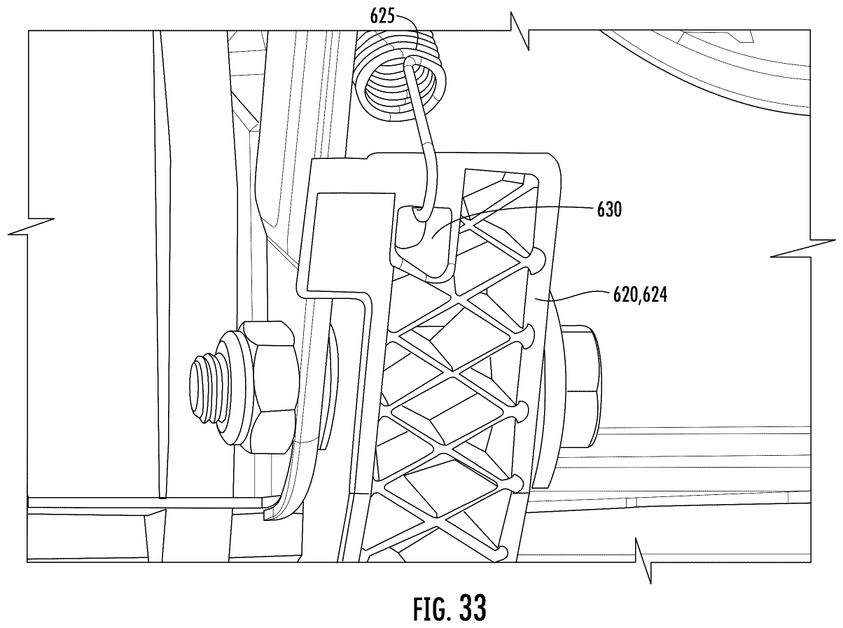

Turning now to FIGS. 24 through 30, various features of or adjacent to the scraper assembly 190 will be described in further detail. In at least one example embodiment, the scraper assembly 190 includes a scraper bar 615 configured to scrape the ground. The scraper bar 615 may be coupled to the auger 106 or one or more wheels 114 of the snow blower 100. In some aspects, one or more springs 625 (shown in FIGS. 32 through 33) may be provided between the scraper bar 615 and the auger 106 or wheel(s) 114 such that the scraper bar 615 operates in a spring-loaded manner. For example, the one or more springs 625 may bias the scraper bar 615 in a downward direction toward the ground relative to the auger housing 108 and the spring(s) 625 may be compressed when the scraper bar 615 contacts the ground.

In some example embodiments, at least two attachment members 620 extend from the scraper bar 615. The scraper bar 615 extends parallel to the auger axis A_{A} and the at least two attachment members 620 may extend perpendicularly from the scraper bar 615. Moreover, the at least two attachment members 620 are laterally spaced apart along the scraper bar 615. For example, the at least two attachment members 620 may include a first attachment member 622 adjacent the first end 503 and a second attachment member 624 adjacent the second end 504.

Turning to FIGS. 32 through 33, the at least two attachment members 620 may be configured to be coupled to the at least one spring 625. For example, the scraper assembly 190, including the scraper bar 615 and the at least two attachments members 620, may be removably coupled to the auger housing 108 via the at least one spring 625. In at least one example embodiment, the at least two attachment members 620 include an engagement member 630 for engaging at least a portion, such as a wire, of the at least one spring 625. In some example embodiments, as shown FIG. 32, the engagement member 630 may define a recess for receiving at least a portion of the at least one spring 625. In additional example embodiments, as shown in FIG. 33, the engagement member 630 may include a slot defined by the at least two attachment members 620 for receiving at least a portion of the at least one spring 625.

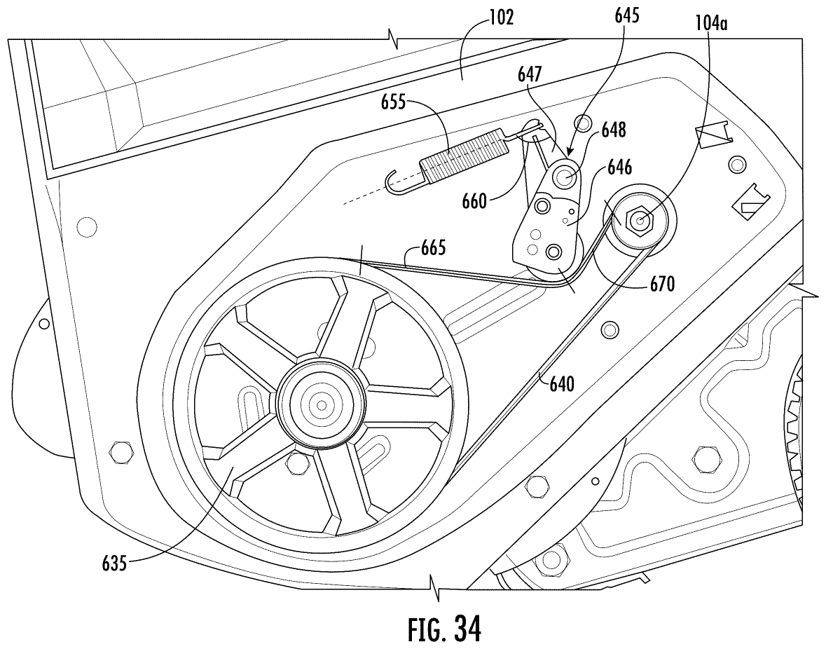

Turning now to FIGS. 34 through 36, as discussed above with respect to FIG. 2, the snow blower 100 includes one or more motors 104. More particularly, the snow blower 100 includes the motor 104a (also referred to as an auger motor) configured to rotate the auger 106. The snow blower 100 may also include an auger pulley 635 supported by the frame 102, a belt 640 coupled between the motor 104a and the auger pulley 635, and a tensioner 645 supported by the frame 102 and configured to exert pressure on the belt 640.

The belt 640 is configured to transfer rotational motion from the element motor 104a to the auger pulley 635 to motivate rotation of the auger 106. For example, the auger pulley 635 may be coupled to a driveshaft 650 (shown in FIGS. 24 through 30) of the rotatable auger such that rotation of the auger pulley 635 causes rotation of the driveshaft 650 and, thereby, the auger 106 about the auger axis A_{A}.

As shown in FIG. 34, the tensioner 645 may be mounted to the frame between the motor 104a and the auger pulley 635. The tensioner 645 includes a first arm 646 and a second arm 647. The first arm 646 and the second arm 647 are rotatable coupled to the frame 102 by a pin 648 and are configured to rotate about the pin 648. In at least one example embodiment, the tensioner 645 is formed of a polytetrafluoroethylene (PTFE) material, which may reduce scratching or rubbing of the tensioner 645 on the frame 102 when the tensioner 645 is rotated.

Additionally, a tension spring 655 may be coupled to the frame 102 and the tensioner 645. For example, the tension spring 655 may be coupled to the second arm 647 of the tensioner 645. The tension spring 655 is configured to bias the tensioner 645 such that the tensioner 645 is rotated about the pin 648 to an engaged position, shown in FIG. 34, and the first arm 646 exerts pressure on the belt 640. The tension spring 655 and the second arm 647 of the tensioner 645 define a tensioner angle 660. In the engaged position, shown in FIG. 34, the tensioner angle 660 may be about 90°.

Moreover, in the engaged position shown in FIG. 34, the belt 640 defines a first belt span 665 between the auger pulley 635 and the tensioner 645 and a second belt span between the motor 104a and the tensioner 645. The first belt span 665 may be greater than the second belt span 670. For example, the first belt span 665 may be about two times greater than the second belt span 670. In such embodiments, the first belt span 665 and the second belt span 670 may reduce effects of misalignment of the belt 640 relative to one or more of the auger pulley 635, the motor 104a, and the tensioner 645.

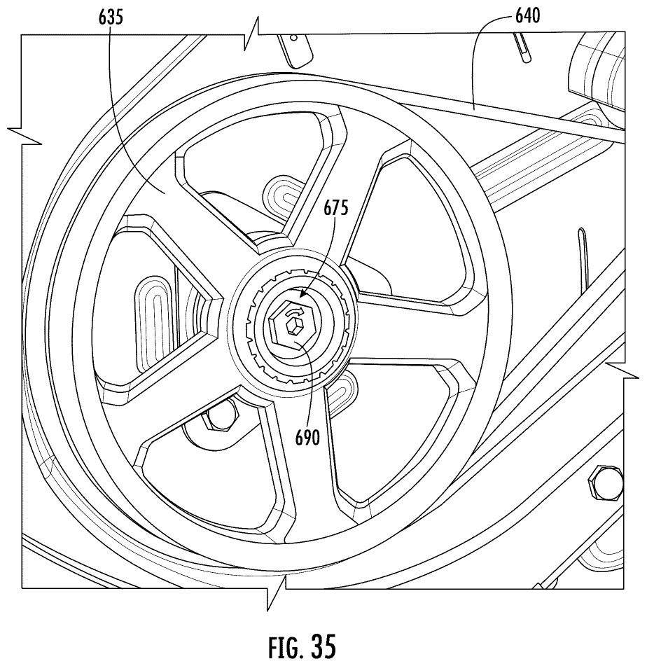

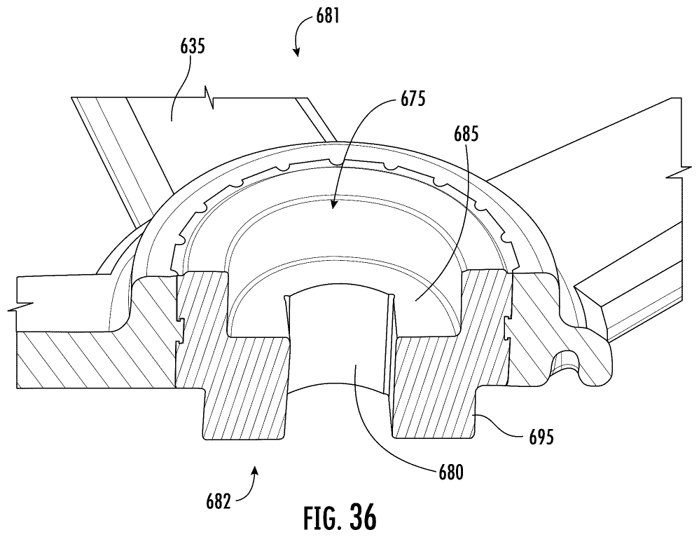

Turning to FIGS. 35 and 36, the auger pulley 635 includes a central portion 675. The central portion 675 of the auger pulley 635 defines a pulley opening 680 and a recessed portion 685 circumscribing the pulley opening 680. The central portion 675 of the auger pulley 635 is configured to receive a pulley fastener 690 for securing the auger pulley 635 to the frame 102 or the driveshaft 650 of the auger 106. The pulley fastener 690 may include a bolt, a screw, or other fastener for securing the auger pulley 635 to the frame 102 or the driveshaft 650. Moreover, the pulley fastener 690 may be reverse threaded such that rotation of the auger pulley 635 during operation of the snow blower 100 does not loosen the pulley fastener 690.

With reference to FIG. 36, the pulley opening 680 may extend through the central portion 675 from a first pulley side 681 to a second pulley side 682. The pulley opening 680 is configured to receive at least a portion of the pulley fastener 690. The recessed portion 685 of the auger pulley 635 extends partially through the central portion 675 from the first pulley side 681 towards the second pulley side 682. The recessed portion 685 is also configured to receive at least a portion of the pulley fastener 690. For example, the pulley fastener 690 may be seated within the recessed portion 685 such that the pulley fastener does not extend past an end face of the central portion 675 of the auger pulley 635 or is flush with the end face of the central portion 675 of the auger pulley 635.

In at least one example embodiment, the central portion 675 of the auger pulley 635 includes an extension 695 extending from the second pulley side 682. The extension 695 may be annular and define at least a portion of the pulley opening 680. Moreover, a portion of the frame 102 or the driveshaft 650 may be configured to receive the extension 695.

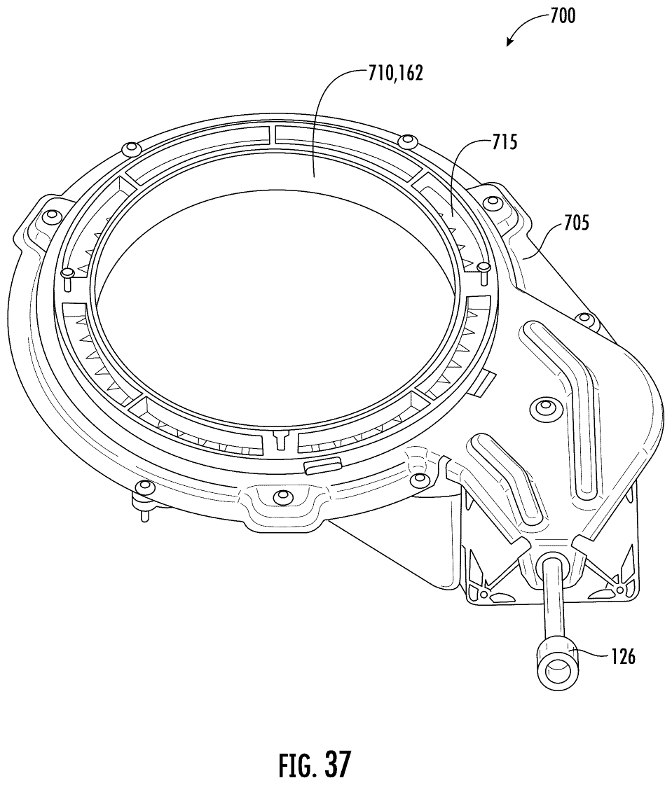

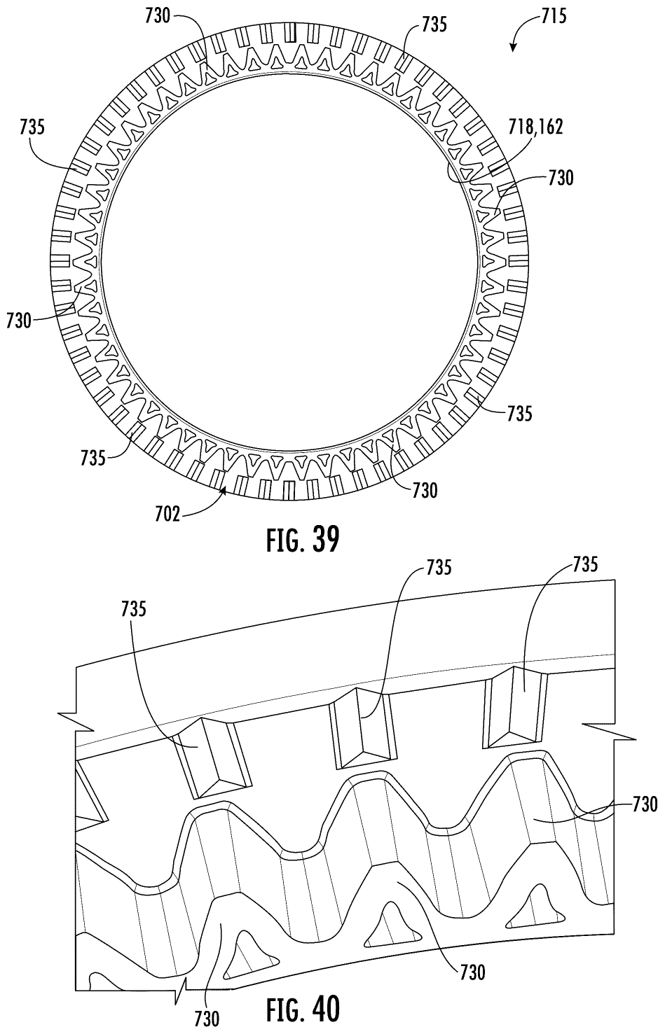

Turning to FIGS. 37 through 41, various features of a chute drivetrain assembly 700 for the chute 116 are illustrated. In at least one example embodiment, the chute drivetrain assembly 700 includes a mount 705. The mount 705 is configured to be coupled to the frame 102 of the snow blower 100. Additionally, the mount 705 is configured to secure the chute 116 to the frame 102. As shown in FIG. 37, the mount 705 defines an opening 710 forming at least a portion of the outlet opening 162. Moreover, the chute lever 126 is operatively coupled to the mount 705 for selectively rotating the chute 116, as will be discussed in greater detail below.

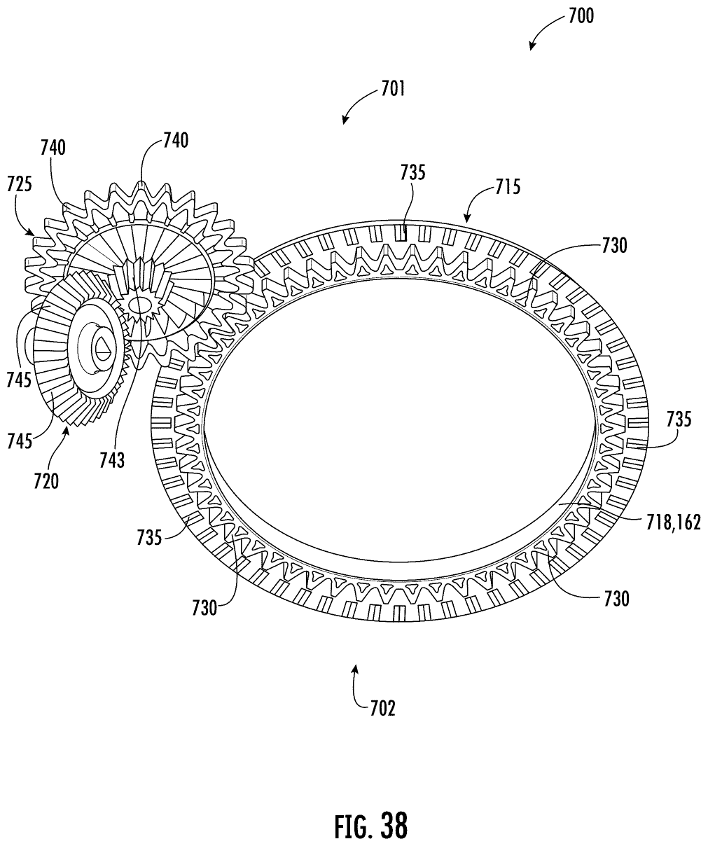

With reference to FIG. 38, the chute drivetrain assembly 700 includes a plurality of gears. For example, the chute drivetrain assembly 700 includes a chute gear 715 configured to be coupled to the chute 116, a first gear 720 configured to be coupled to the chute lever 126, and a second gear 725 coupled between the first gear 720 and the chute gear 715. The first gear 720 is configured to translate rotational motion of the chute lever 126 to the second gear 725 and the second gear 725 is configured to translate rotational motion to the chute gear 715.

As shown in FIGS. 38 through 40, the chute gear 715 defines a gear opening 718. The gear opening 718 corresponds with the opening 710 and defines at least a portion of the outlet opening 162. The chute gear 715 includes a first plurality of teeth 730 extending from a second gear side 702 opposite a first gear side 701. The first plurality of teeth 730 extend about a perimeter of the chute gear 715. For example, the first plurality of teeth 730 may be disposed about an inner perimeter of the chute gear 715 adjacent the gear opening 718. The first plurality of teeth 730 may be equally spaced about the perimeter of the chute gear 715. Additionally, the chute gear 715 defines a plurality of recesses, such as a plurality of detents 735, extending about the perimeter of the chute gear 715. The plurality of detents 735 may be disposed on the second gear side 702 of the chute gear 715 and may extend about an outer perimeter of the chute gear 715. For example, the plurality of detents 735 may be outbound of and circumscribe the first plurality of teeth 730. The plurality of detents 735 may be equally spaced about the perimeter of the chute gear 715. In some example embodiments, each of the plurality of detents 735 may be adjacent the first plurality of teeth 730. In other example embodiments, the plurality of detents 735 may be offset from the first plurality of teeth 730. Moreover, as shown in FIG. 40, the plurality of detents 735 may have a general V-shape or triangular shape. In other example embodiments, the plurality of detents 735 may include a rounded or other polygonal shape.

Referring again to FIG. 38, the second gear 725 includes a second plurality of teeth 740 extending about a perimeter of the second gear 725. The second plurality of teeth 740 are configured to engage the first plurality of teeth of the chute gear 715. Additionally, the second gear 725 includes a third plurality of teeth 743 extending from the second gear side 702 of the second gear 725. For example, the third plurality of teeth 743 may extend generally perpendicularly to the second plurality of teeth 740.

The first gear 720 includes a fourth plurality of teeth 745 extending about a perimeter of the first gear 720. The first gear 720 may be oriented generally perpendicularly, such as at about a 90° angle, to the second gear 725 such that the fourth plurality of teeth 745 are configured to engage the third plurality of teeth 743 of the second gear 725. For example, the first gear 720 may include a bevel gear. Accordingly, the first gear 720 is configured to transfer rotational motion of the chute lever 126 to the second gear 725 via the fourth plurality of teeth 745 and the third plurality of teeth 743. The second gear 725 is configured to transfer the rotational motion to the chute gear 715 via the second plurality of teeth 740 and the first plurality of teeth 730 and, thereby, rotate the chute 116 in a desired direction. More particularly, rotation of the chute lever 126 in a clockwise direction rotates the chute 116 in the clockwise direction about the auger axis A_{A} and, similarly, rotation of the chute lever 126 in a counter-clockwise direction rotates the chute 116 in the clockwise direction about the auger axis A_{A} via the chute drivetrain assembly 700.

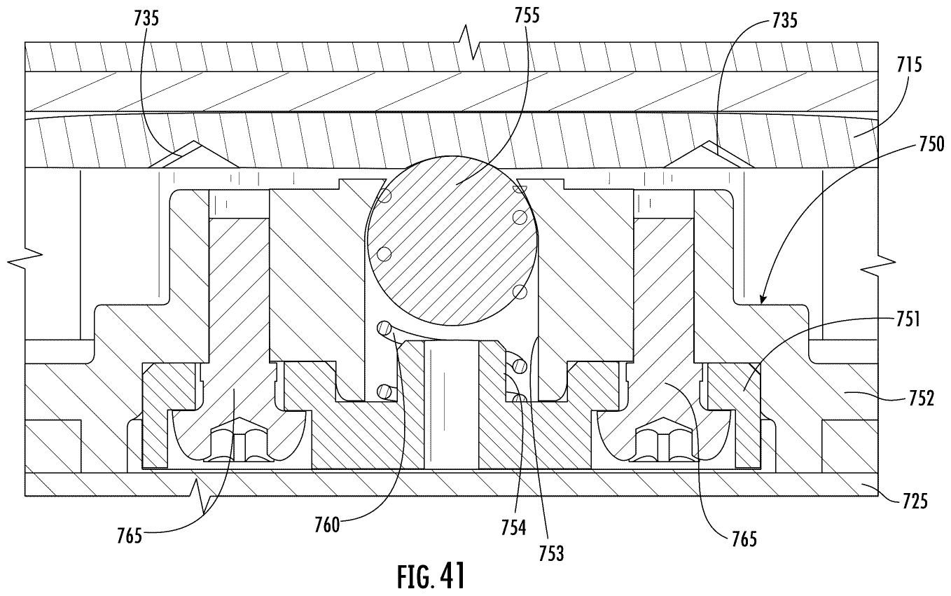

Turning to FIG. 41, the chute drivetrain assembly 700 may include at least one engagement assembly 750 for securing the chute gear 715, and thereby the chute 116, in a desired position. The engagement assembly 750 may be coupled to or integral with the second gear 725. In at least one example embodiment the at least one engagement assembly 750 includes a housing. The housing may include a first housing portion 751 and a second housing portion 752. The second housing portion 752 defines a channel 753 configured to receive a ball 755 and a biasing member 760. In at least one example embodiment, the biasing member 760 includes a spring. Additionally, the at least one engagement assembly 750 may include a plurality of engagement assemblies 750 spaced about the perimeter of the second gear 725. For example, the at least one engagement assembly 750 may include three of the engagement assemblies 750 spaced about the perimeter of the second gear 725 in some embodiments. Moreover, the plurality of engagement assemblies 750 may be equally spaced about the perimeter of the second gear 725.

The first housing portion 751 may include a protrusion 754 extending from a surface of the first housing portion 751 and into the channel 753. At least a portion of the biasing member 760 may be coupled to or at least partially surround the protrusion 754. Moreover, the at least one engagement assembly may include one or more fasteners 765 configured to secure the first housing portion 751 to the second housing portion 752.

The biasing member 760 may be coupled to or at least partially surround the ball 755. Additionally, or alternatively, the ball 755 may be at least partially seated in an end of the biasing member 760. The biasing member 760 may be a spring in some example embodiments and is configured to bias the ball 755 between a disengaged position and an engaged position. In the engaged position, the ball 755 is engaged with the plurality of detents 735. In the disengaged position, the ball 755 may overcome the force of the biasing member 760 and move into the channel 753 towards the protrusion 754. For example, the ball 755 may contact the protrusion 754 in the disengaged position. The ball 755 may move between the engaged and disengaged position as the second gear 725 and the chute gear 715 rotate. In the engaged position, the chute gear 715 and the chute 116 are secured in the desired position, which may prevent movement of the chute 116 and reduce undesired noise during operation of the snow blower 100.

In at least one example embodiment, the engagement assembly 750 includes a ball and detent assembly, as discussed above and shown in FIG. 41. In other example embodiments, the engagement assembly 750 may include a pin and detent assembly. In such embodiments, the engagement assembly 750 may include a pin configured to engage the plurality of detents 735 in place of the ball 755.

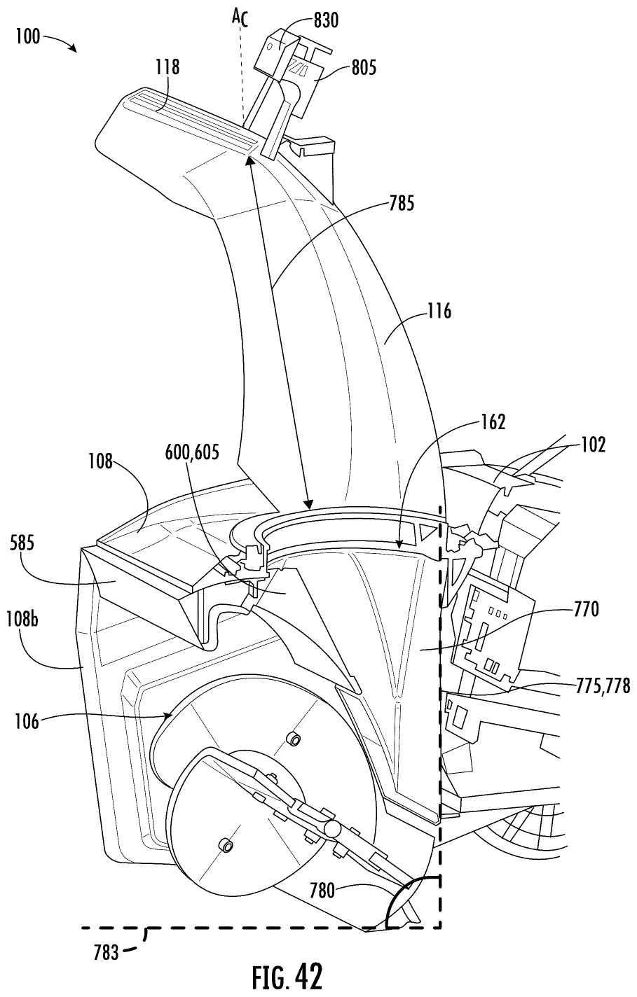

Turning to FIGS. 42 through 49, various features of or adjacent to the chute 116 will be described in further detail. In at least one example embodiment, the snow blower 100 includes a chute base 770 extending from the chute 116 into the auger housing 108 rearward of the auger 106. The chute base 770 may at least partially defining the outlet opening 162. Additionally, the chute base 770 may define a rear wall 775 of the auger housing 108. The rear wall 775 may extend perpendicular to a direction of travel of the snow blower 100. For example, as shown in FIG. 42, a rear wall axis extending parallel with the rear wall 775 forms a rear wall angle 780 relative to a ground axis 783 extending perpendicular to the ground. In at least one example embodiment, the rear wall angle is about 90°. Mounting the chute bases 770 within the auger housing 108 such that the rear wall 775 is perpendicular to the ground may permit the throw distance of snow to be increased during operation of the snow blower 100.

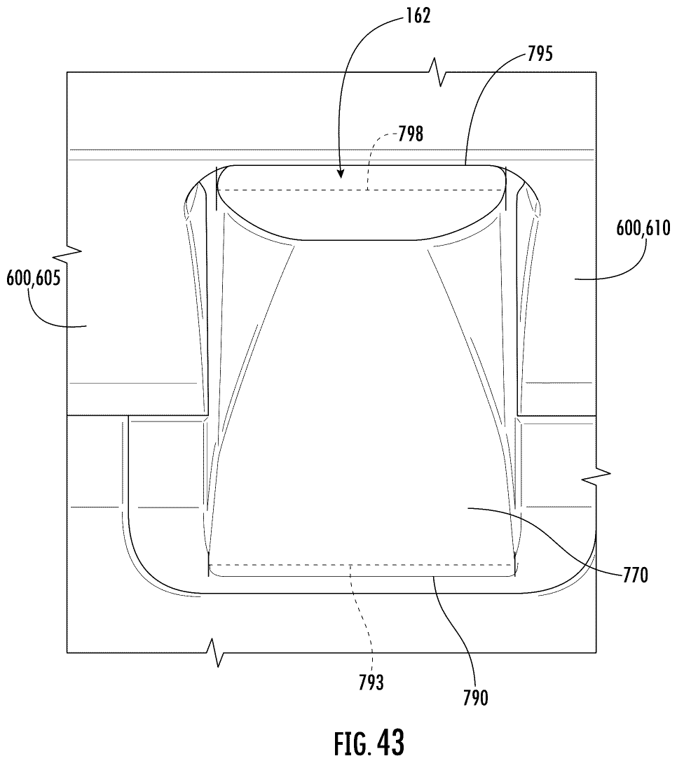

Turning to FIG. 43, the chute base 770 defines at least a portion of the outlet opening 162. For example, the chute base 770 defines a first opening 790 of the outlet opening 162 and a second opening 795 of the outlet opening 162 opposite the first opening 790. The first opening 790 may be within the auger housing 108 adjacent the auger 106 and the second opening 795 may be adjacent the chute 116. In at least one example embodiment, the first opening 790 defines a first opening width 793 and the second opening 795 defines a second opening width 798. In some example embodiments, the first opening width 793 and the second opening width 798 may be substantially the same. For example, a ratio of the second opening width 798 to the first opening width 793 may be about 0.9. If the first opening width 793 and the second opening width 798 are substantially the same, there is little to no convergence from the first opening 790 to the second opening 795, which may reduce clogging and increase throw distance of snow. In other example embodiments, the first opening width 793 may be different than the second opening width 798. For example, the first opening width may be greater than or less than the second opening width 798.

With reference to FIG. 42, the chute 116 includes a chute height 785 extending along the auger axis A_{A} from the frame 102 to the moveable element 118. The chute height 785 may be greater than or equal to about 350 mm and less than or equal to about 450 mm. For example, the chute height 785 may be about 400 mm. The chute height 785 may improve the throw distance of the snow from the outlet opening 162 and provide a tighter stream of snow. For example, a chute height 785 greater than or equal to 350 mm may enable the snow to stay converged within the chute 116 for a longer period of time.

The chute 116 also includes a deflector sheet 800 coupled to an interior surface of one or both of the chute 116 and the moveable element 118. In at least one example embodiments, at least a portion of the deflector sheet 800 may be fixedly coupled to the interior surface of the moveable element 118 such that the deflector sheet 800 is moveable relative to the chute 116. For example, the deflector sheet 800 may move along with movement of the moveable element 118 and the deflector sheet 800 may be configured to move or slide relative to the interior surface of the chute 116. In other example embodiments, at least a portion of the deflector sheet may be fixedly coupled to the interior surface of the chute 116 such that the moveable element 118 moves or slides relative to the deflector sheet 800.

In at least one example embodiment, the deflector sheet 800 conforms to a shape of the interior surface of the chute 116 and the moveable element 118. Accordingly, the deflector sheet 800 may create continuous curvature between the chute 116 and the moveable element 118, such as at a hinge between the chute 116 and the moveable element 118, which may increase a throw distance of the snow when the moveable interface is lowered.

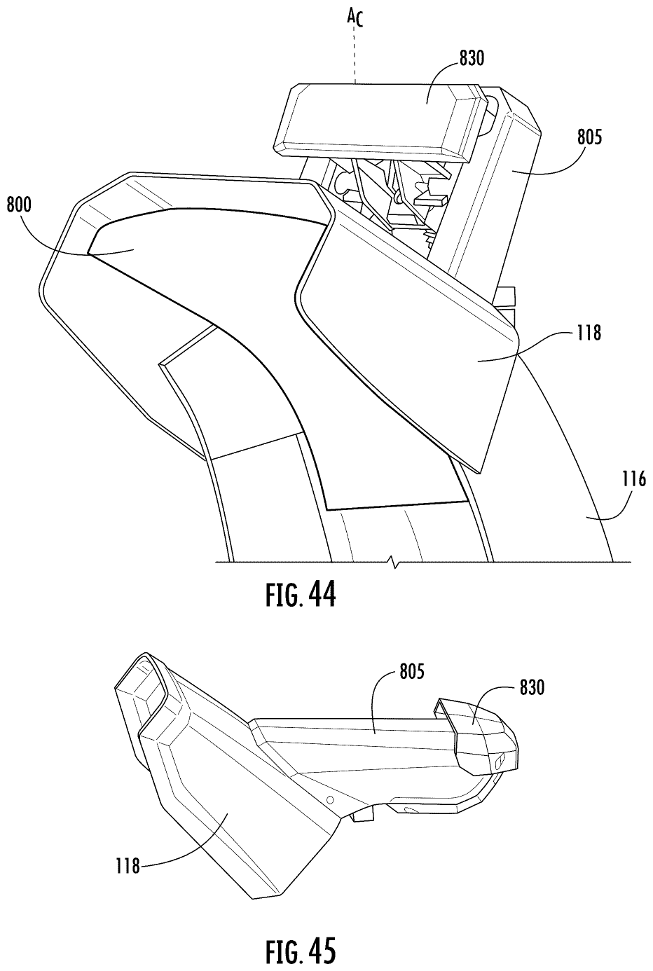

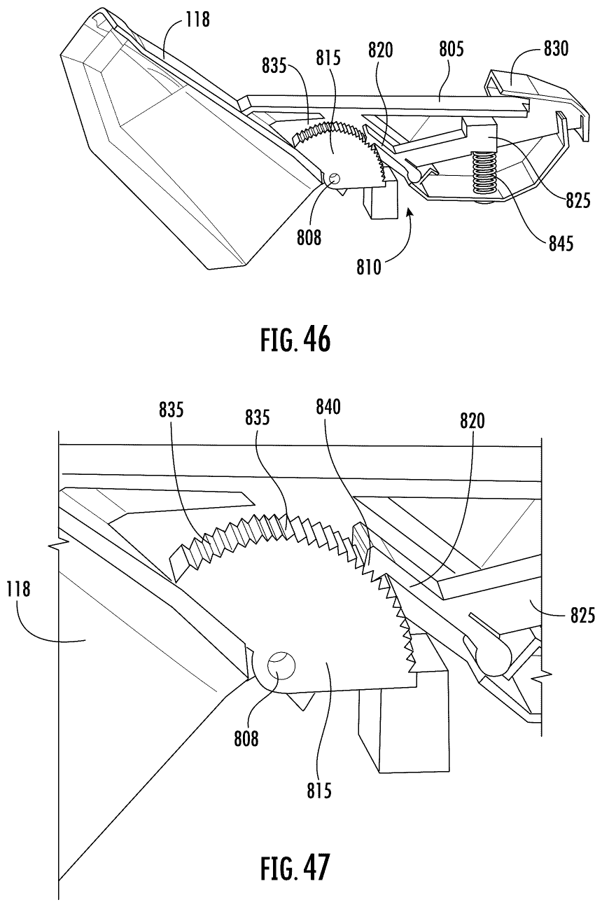

Turning to FIGS. 44 through 47, the chute 116 includes the moveable element 118 (also referred to as a chute flap) and a flap lever 805. An operator of the snow blower 100 may selectively rotate the moveable element 118 about an axis perpendicular to the chute axis Ac via the flap lever 805. For example, the moveable element 118 may rotate relative to the chute 116 about a hinge point 808 (shown in FIGS. 46 through 47).

With reference to FIGS. 46 through 47, at least a portion of a ratchet assembly 810 may be disposed in the flap lever 805 and coupled to the moveable element 118. The ratchet assembly 810 includes a rotatable member 815 coupled to the moveable element 118, an engagement member 820 configured to engage the rotatable member 815, an elongated arm 825 extending from the engagement member 820, and an actuator 830 configured to actuate the engagement member 820 via the elongated arm 825.

At least a portion of the rotatable member 815 is coupled to the moveable element 118 and is configured to rotate about the hinge point 808, thereby rotating the moveable element 118. The rotatable member 815 includes a plurality of teeth for engaging the engagement member 820. Additionally, the engagement member 820 may include one or more teeth 840 for engaging the plurality of teeth 835 of the rotatable member 815. For example, the one or more teeth 840 of the engagement member 820 may be engaged with the plurality of teeth 835 of the rotatable member 815 in an engaged position and the one or more teeth 840 of the engagement member 820 may be disengaged from the plurality of teeth 835 of the rotatable member 815 in a disengaged position.

Actuation of the actuator 830 is configured to disengage the one or more teeth 840 of the engagement member 820 from the plurality of teeth 835 of the rotatable member 815. For example, applying a force, such as depressing, the actuator 830 may release the one or more teeth 840 of the engagement member 820 from the plurality of teeth 835 of the rotatable member 815 and releasing the actuator 830 may engage the one or more teeth 840 of the engagement member 820 with the plurality of teeth 835 of the rotatable member 815.

Additionally, the ratchet assembly 810 includes a biasing member 845 disposed in the flap lever 805 and coupled to the elongated arm 825. The biasing member 845 may be configured to bias the elongated arm 825 and the engagement member 820 between the engaged and the disengaged position. In an unbiased state, such as when no force is applied to the actuator 830, the biasing member 845 is configured to bias the elongated arm 825 and the engagement member 820 to the engaged position. For example, the biasing member 845 may bias the elongated arm 825 upward or in a counter-clockwise direction, which rotates the engagement member 820 downward and in the counter-clockwise direction such that the one or more teeth 840 engage the plurality of teeth 835 of the rotatable member.

To rotate the moveable element 118 to a desired position, an operator of the snow blower 100 may apply a force to or depress the actuator 830 such that the elongated arm 825 is moved downward or in a clockwise direction to overcome the force of the biasing member 845. Accordingly, the engagement member 820 also moves upward and in the clockwise direction such that the one or more teeth 840 disengage from the plurality of teeth 835. In the disengaged position, the operator may rotate the moveable element 118 in the clockwise or counter-clockwise direction to the desired position using the flap lever 805. Release of the actuator 830 causes the elongated arm 825 and the engagement member 820 to move to the engaged position, as discussed above, such that the moveable element 118 is secured in the desired position.

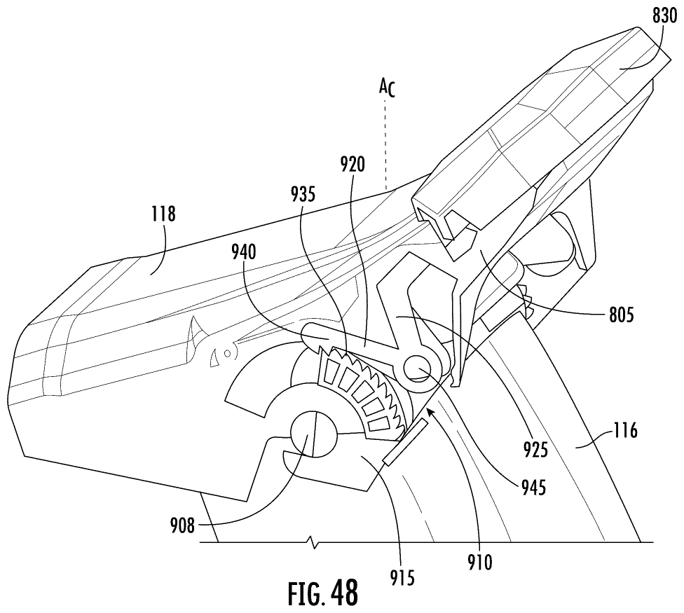

Turning to FIG. 48, at least a portion of a ratchet assembly 910 may be disposed in the flap lever 805 and coupled to the moveable element 118. The ratchet assembly 910 may be similar or analogous to the ratchet assembly 810 discussed above with respect to FIGS. 46 through 47 and may be incorporated into the snow blower 100 in place of the ratchet assembly 810.

For example, the ratchet assembly 910 includes a rotatable member 915 coupled to the moveable element 118, an engagement member 920 configured to engage the rotatable member 915, an elongated arm 925 extending from the engagement member 920, and the actuator 830 configured to actuate the engagement member 920 via the elongated arm 925.

The rotatable member 915 is rotatably coupled to the chute 116 at a hinge point 908. Accordingly, the rotatable member 915 is configured to rotate about the hinge point 908, thereby rotating the moveable element 118. The rotatable member 915 includes a plurality of teeth 935 for engaging one or more teeth 940 extending from the engagement member 920. Accordingly, the one or more teeth 940 of the engagement member 920 may be engaged with the plurality of teeth 935 of the rotatable member 915 in an engaged position and the one or more teeth 940 of the engagement member 920 may be disengaged from the plurality of teeth 935 of the rotatable member 915 in a disengaged position.

In at least one example embodiment, the engagement member 920 and the elongated arm 925 are coupled at a pivot point 945. The engagement member 920 and the elongated arm 925 are configured to rotate between the engaged position and the disengaged position about the pivot point 945. More particularly, the actuator 830 may be configured to rotate the engagement member 920 and the elongated arm 925 from the engaged position to the disengaged position. For example, applying a force, such as depressing, the actuator 930 may apply a corresponding force to the elongated arm 925 and causing the elongated arm 925 and the engagement member 920 to rotate about the pivot point 945 in a clockwise direction from the engaged position to the disengaged position. In the disengaged position, the one or more teeth 940 disengage from the plurality of teeth 935. Additionally, the moveable element 118 and the rotatable member 915 may be rotated to a desired position via the flap lever 805.

When no force is applied to the actuator 830, such as when the actuator is released, the elongated arm 925 and thereby the engagement member 920 may rotate in a counter-clockwise direction about the pivot point 945 to the engaged position. In the engaged position, the one or more teeth 940 of the engagement member 920 engaged with the plurality of teeth 935 of the rotatable member 915 such that the rotatable member 915 and the moveable element 118 are secured in the desired position.

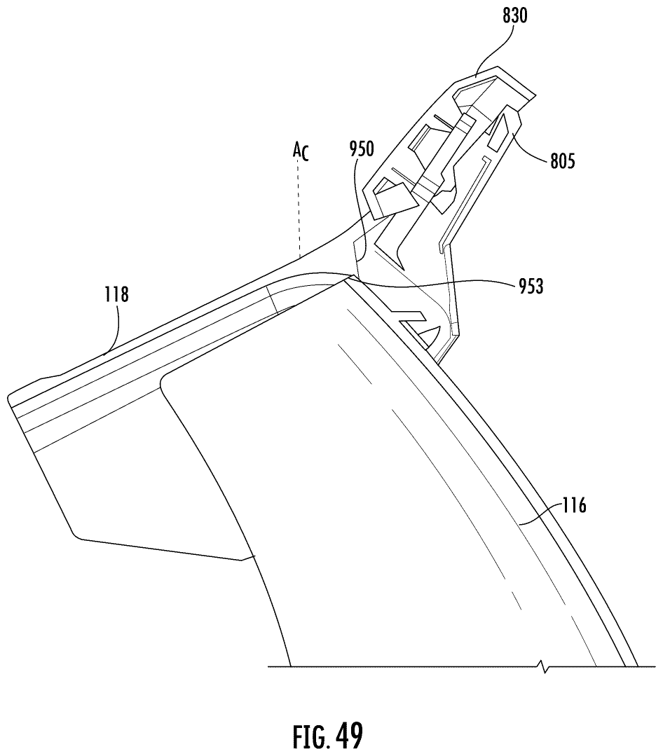

Turning to FIG. 49, a cross-sectional view of the chute 116 and the moveable element 118 is illustrated. As discussed above with respect to FIGS. 44 through 48, the moveable element 118 is configured to rotate relative to the chute 116. In some example embodiments, the moveable element 118 includes a protrusion 950 extending from an interior surface of the moveable element 118. The protrusion 950 may be adjacent to flap lever 805 and configured to extend towards an end surface 953 of the chute 116. Accordingly, the protrusion 950 may provide a seal between the moveable element 118 and the end surface 952 of the chute 116, which may prevent snow and other particles from leaking out of the chute 116 between the end surface 952 and the moveable element 118.

Further aspects of the invention are provided by one or more of the following embodiments:

A snow blower comprising: a frame comprising a scaffolding base and one or more body panels; a rotatable auger rotatably mounted to the frame; a battery compartment attached to the frame to receive a battery pack; and a compartment cover movably mounted to the frame to move between an open position permitting access to the battery compartment and a closed position restricting access to the battery compartment, the compartment cover comprising a non-permeable door body disposed above the battery compartment, and one or more primary magnetic elements mounted to the non-permeable door body, the one or more magnetic elements being magnetically engaged with the frame at the closed position to bias the compartment cover toward the closed position.

The snow blower of any one or more of the embodiments, wherein the frame further comprises one or more secondary magnetic elements, the one or more secondary magnetic elements being fixed to the one or more body panels in selective matched engagement with the primary magnetic elements in the closed position.

The snow blower of any one or more of the embodiments, wherein the one or more body panels comprises a top body panel disposed above the battery compartment, and wherein the compartment cover is rotatably mounted to the frame to pivot relative to the top body panel between the open position and the closed position.

The snow blower of any one or more of the embodiments, wherein the top body panel attached to the scaffolding base and disposed above the rotatable auger, and wherein the compartment cover is rotatably fixed to the top body panel as a pre-assembled unit to attach to the scaffolding base through the top body panel.

The snow blower of any one or more of the embodiments, wherein the one or more body panels comprises a top body panel disposed above the rotatable auger, and wherein the frame further comprises an auger housing defining a front opening and within which the rotatable auger is mounted, the auger housing being secured to the top body panel at one or more snap-fit tabs in friction-fit engagement with the auger housing.

The snow blower of any one or more of the embodiments, wherein the battery compartment comprises a compartment box attached to scaffolding base and defining one or more battery wells to receive the battery pack therein.

The snow blower of any one or more of the embodiments, further comprising: a plurality of mechanical fasteners extending between the compartment box and the scaffolding base to secure the compartment box to the scaffolding base; and a plurality of polymer isolators disposed about the plurality of mechanical fasteners between the mechanical fasteners and the compartment box to dampen vibrations from the scaffolding base to the compartment box.

A snow blower comprising: a frame comprising a scaffolding base, one or more body panels, and an auger housing, the one or more body panels comprising a top body panel, the auger housing a top wall and defining a front opening permitting snow therethrough; a rotatable auger rotatably mounted within the auger housing below the top body panel; and a chute extending from the top body panel above the rotatable auger, wherein the auger housing is secured to the top body panel at one or more snap-fit tabs in friction-fit engagement with the auger housing.

The snow blower of any one or more of the embodiments, further comprising: a battery compartment attached to the frame to receive a battery pack; a compartment cover movably mounted to the frame to move between an open position permitting access to the battery compartment and a closed position restricting access to the battery compartment, the compartment cover comprising a non-permeable door body disposed above the battery compartment, and one or more primary magnetic elements mounted to the non-permeable door body to bias the compartment cover toward the closed position; and one or more secondary magnetic elements in selective matched engagement with the primary magnetic elements in the closed position.

The snow blower of any one or more of the embodiments, wherein the one or more secondary magnetic elements are fixed to the top body panel.

The snow blower of any one or more of the embodiments, wherein the compartment cover is rotatably mounted to the frame to pivot relative to the top body panel between the open position and the closed position.

The snow blower of any one or more of the embodiments, wherein the top body panel attached to the scaffolding base and disposed above the rotatable auger, and wherein the compartment cover is rotatably fixed to the top body panel as a pre-assembled unit to attach to the scaffolding base through the top body panel.

The snow blower of any one or more of the embodiments, further comprising a compartment box attached to scaffolding base and defining one or more battery wells to receive a battery pack therein.

The snow blower of any one or more of the embodiments, further comprising: a plurality of mechanical fasteners extending between the compartment box and the scaffolding base to secure the compartment box to the scaffolding base; and a plurality of polymer isolators disposed about the plurality of mechanical fasteners between the mechanical fasteners and the compartment box to dampen vibrations from the scaffolding base to the compartment box.

A snow blower comprising: a frame; a rotatable auger rotatably mounted to the frame; a battery compartment attached to the frame to receive a battery pack, the battery compartment comprising a compartment box attached to the frame and defining one or more battery wells to receive the battery pack therein; a plurality of mechanical fasteners extending between the compartment box and the frame to secure the compartment box to the frame; and a plurality of polymer isolators disposed about the plurality of mechanical fasteners between the mechanical fasteners and the compartment box to dampen vibrations from the frame to the compartment box.

The snow blower of any one or more of the embodiments, wherein the frame comprises a top body panel disposed above the battery compartment.

The snow blower of any one or more of the embodiments, further comprising: a compartment cover movably mounted to the frame to move between an open position permitting access to the battery compartment and a closed position restricting access to the battery compartment, the compartment cover comprising a non-permeable door body disposed above the battery compartment, and one or more primary magnetic elements mounted to the non-permeable door body to bias the compartment cover toward the closed position; and one or more secondary magnetic elements in selective matched engagement with the primary magnetic elements in the closed position.

The snow blower of any one or more of the embodiments, wherein the frame comprises a top body panel disposed above the battery compartment, wherein the one or more secondary magnetic elements are fixed to the top body panel.

The snow blower of any one or more of the embodiments, wherein the compartment cover is rotatably mounted to the frame to pivot relative to the top body panel between the open position and the closed position.

The snow blower of any one or more of the embodiments, wherein the frame further comprises a scaffolding base, wherein the top body panel attached to the scaffolding base and disposed above the rotatable auger, and wherein the compartment cover is rotatably fixed to the top body panel as a pre-assembled unit to attach to the scaffolding base through the top body panel.

A snow blower comprising: a frame; a rotatable auger rotatably mounted to the frame; a handle assembly attached to and extending rearward from the frame; a bail control bar movably attached to the handle assembly in operable communication with the rotatable auger, the bail control bar being movable between a released position restricting activation of the rotatable auger and an engaged position permitting activation of the rotatable auger; and a sensor array comprising one or more electric field sensors in operable communication with the bail control bar, the sensor array being configured to detect the bail control bar in the engaged position.

The snow blower of any one or more of the embodiments, further comprising: a control panel mounted on the handle assembly apart from the frame; a bar linkage fixed to the bail control bar to move therewith; and a permanent magnet mounted on the bar linkage to move between the released position and the engaged position, wherein the sensor array comprises a first Hall effect sensor fixed within the control panel in selective alignment with the permanent magnet at the engaged position.

The snow blower of any one or more of the embodiments, wherein the sensor array further comprises a second Hall effect sensor fixed within the control panel apart from the first Hall effect sensor, the second Hall effect sensor being in selective alignment with the permanent magnet at the released position.

The snow blower of any one or more of the embodiments, further comprising a start input attached to the handle assembly apart from the bail control bar.

The snow blower of any one or more of the embodiments, further comprising a controller connected to the sensor array and the start input and configured to control an operation of the rotatable auger, the controller configured to: receive an auger control command, determine the bail control bar is in the engaged position based on the sensor array, and control, in response to determining that the bail control bar is in the engaged position, the rotatable auger based on the received auger control command.

The snow blower of any one or more of the embodiments, wherein the controller is further configured to: determine the bail control bar is in the released position based on the sensor array; and halt the rotatable auger in response to determining that the bail control bar is in the released position.

The snow blower of any one or more of the embodiments, further comprising: a battery compartment attached to the frame to receive a battery pack; a control panel mounted on the handle assembly apart from the frame, the control panel comprising a battery meter; and a controller in electrical communication with the battery compartment, the controller being configured to: determine a power capacity of the battery pack, and direct illumination of the battery meter according to the determined power capacity of the battery pack.

The snow blower of any one or more of the embodiments, wherein the battery meter comprises a plurality of discrete light emitting diodes, and wherein direct illumination of the battery meter comprises determining a number of light emitting diodes of the plurality of light emitting diodes to illuminate according to the determined power capacity.

The snow blower of any one or more of the embodiments, wherein the battery pack is a first battery pack, wherein the battery meter is a first battery meter, and wherein the controller is further configured to: determine a power capacity of the second battery pack, and direct illumination of the second battery meter according to the determined power capacity of the second battery pack.

The snow blower of any one or more of the embodiments, further comprising: a light source mounted on the handle assembly and directed forward to illuminate a path of the snow blower.

The snow blower of any one or more of the embodiments, further comprising a hand warmer selectively fastened to the handle assembly, the hand warmer comprising: a fabric substrate wrapped onto a portion of the handle assembly, a resistive heating element fixed to the fabric substrate, and an element battery in electrical communication with the resistive heating element apart from the frame.

A snow blower comprising: a frame; a rotatable auger rotatably mounted to the frame; a handle assembly attached to and extending rearward from the frame; a battery compartment attached to the frame to receive a battery pack; a control panel mounted on the handle assembly apart from the frame, the control panel comprising a battery meter; and a controller in electrical communication with the battery compartment, the controller being configured to: determine a power capacity of the battery pack, and direct illumination of the battery meter according to the determined power capacity of the battery pack.

The snow blower of any one or more of the embodiments, further comprising a bail control bar movably attached to the handle assembly in operable communication with the rotatable auger, the bail control bar being movable between a released position restricting activation of the rotatable auger and an engaged position permitting activation of the rotatable auger; a sensor array comprising one or more electric field sensors in operable communication with the bail control bar, the sensor array being configured to detect the bail control bar in the engaged position; a bar linkage fixed to the bail control bar to move therewith; and a permanent magnet mounted on the bar linkage to move between the released position and the engaged position, wherein the sensor array comprises a first Hall effect sensor fixed within the control panel in selective alignment with the permanent magnet at the engaged position.

The snow blower of any one or more of the embodiments, further comprising: a start input attached to the handle assembly apart from the bail control bar; wherein the controller is connected to the sensor array and the start input and configured to control an operation of the rotatable auger, the controller configured to: receive an auger control command, determine the bail control bar is in the engaged position based on the sensor array, and control, in response to determining that the bail control bar is in the engaged position, the rotatable auger based on the received auger control command.

A hand warmer selectively fastened to a handle assembly of a snow blower, the hand warmer comprising: a fabric substrate wrapped onto a portion of the handle assembly; a resistive heating element fixed to the fabric substrate; and an element battery in electrical communication with the resistive heating element apart from the frame.

A snow blower, comprising: a frame defining an inlet opening and an outlet opening, the outlet opening being circumferentially bounded about a chute axis; a rotatable auger mounted to the frame rearward from the inlet opening and below the outlet opening to motivate snow to the outlet opening, the rotatable auger defining an auger axis, a first opening adjacent a first side of the auger axis, and a second opening on a second side of the auger axis opposite the first side; one or more wheels mounted to the frame apart from the rotatable auger to support the snow blower; and a chute body extending from the frame along the chute axis above the outlet opening.

The snow blower of any one or more of the embodiments, further comprising: an auger motor supported on the frame; an auger pulley supported by the frame and in mechanical communication with the rotatable auger; a belt coupled to the auger motor and auger pulley, the belt configured to transfer rotational motion from the auger motor to the auger pulley to motivate rotation of the rotatable auger; a tensioner supported by the frame and configured to exert pressure on the belt; and a tensioner spring coupled to the tensioner and a portion of the frame, the tensioner spring configured to bias the tensioner towards the tensioner.

The snow blower of any one or more of the embodiments, wherein an angle defined between the tensioner and the tensioner spring is about 90°.

The snow blower of any one or more of the embodiments, wherein: the belt defines a first belt span between the auger pulley and the tensioner and a second belt span between the tensioner and the auger motor; and the first belt span is greater than the second belt span.

The snow blower of any one or more of the embodiments, wherein the first belt span is about two times greater than the second belt span.

The snow blower of any one or more of the embodiments, wherein the tensioner comprises a polytetrafluoroethylene (PTFE) material.

The snow blower of any one or more of the embodiments, further comprising a pulley fastener configured to secure the auger pulley to the frame, wherein the pulley fastener includes a reverse threaded bolt.

The snow blower of any one or more of the embodiments, further comprising a scraper assembly disposed rearward from the rotatable auger and configured to scrape a path cleared by the snow blower, the scraper assembly comprising: a scraper bar extending parallel to the auger axis; at least two attachment members configured extending from the scraper bar and laterally spaced along the scraper bar; and at least one spring coupled to the frame and configured to engage the at least two attachment member for removably coupling the scraper assembly to the frame.

The snow blower of any one or more of the embodiments, wherein: the rotatable auger includes an auger width extending perpendicular to the auger axis and an auger length extending along the auger axis; an auger area is defined by the auger width and the auger length; and an opening area is defined by a first area of the first opening and a second area of the second opening.

The snow blower of any one or more of the embodiments, wherein a ratio of the opening area to the auger area is about 82%.

The snow blower of any one or more of the embodiments, wherein a center-to-center distance between the auger axis and the first opening and the auger axis and the second opening is less than or equal to about one-fourth of the auger width.

The snow blower of any one or more of the embodiments, wherein: the auger length is greater than or equal to about 150 mm and less than or equal to about 250 mm; and the auger width is greater than or equal to about 50 mm and less than or equal to about 150 mm.

The snow blower of any one or more of the embodiments wherein: the auger length is about 200 mm; and the auger width is about 100 mm.

The snow blower of any one or more of the embodiments, wherein a center portion of the rotatable auger is substantially flat.

The snow blower of any one or more of the embodiments, wherein: the rotatable auger defines a radial axis extending perpendicular to the auger axis; the rotatable auger defines an auger line extending from the auger axis to an end of a central auger section of the rotatable auger; and an angle defined between the radial axis and the auger line is greater than 0°.

The snow blower of any one or more of the embodiments, further comprising a guard coupled to the frame adjacent the inlet opening.

The snow blower of any one or more of the embodiments, further comprising at least one baffle extending from an interior surface of the frame adjacent the outlet opening.

The snow blower of any one or more of the embodiments, wherein the rotatable auger comprises: a first auger segment; a second auger segment; a first auger bracket coupled between the first auger segment and the second auger segment adjacent a first side of the auger axis; a second auger bracket coupled between the first auger segment and the second auger segment adjacent a second side of the auger axis opposite the first side; and a center portion removably coupled the first auger bracket and the second auger bracket.

The snow blower of any one or more of the embodiments, further comprising: a first plurality of fasteners for coupling the center portion to the first auger bracket and the second auger bracket; and a second plurality of fasteners for coupling the first auger segment and the second auger segment to the frame.

The snow blower of any one or more of the embodiments, wherein one or more of the first plurality of fasteners and the second plurality of fasteners include a bolt, a screw, a carriage bolt, or a combination thereof.

A snow blower, comprising: a frame defining an auger housing, an inlet opening, and an outlet opening, the outlet opening being circumferentially bounded about a chute axis; a rotatable auger disposed in the auger housing, the rotatable auger mounted to the frame rearward from the inlet opening and below the outlet opening to motivate snow to the outlet opening; one or more wheels mounted to the frame apart from the rotatable auger to support the snow blower; a chute body extending from the frame along the chute axis above the outlet opening; and a chute drivetrain assembly coupled to the frame and the chute body, the chute drivetrain assembly comprising: a chute gear coupled to the frame and defining at least a portion of the outlet opening, the chute gear configured to rotate the chute body about the chute axis, and a chute lever operatively coupled to the chute gear for rotating the chute body about the chute axis.

The snow blower of any one or more of the embodiments, wherein: the chute gear includes a first surface adjacent the chute body and a second surface opposite the chute body; and a plurality of chute gear teeth extend from the second surface of the chute gear about an interior perimeter of the chute gear.

The snow blower of any one or more of the embodiments, further comprising: a first gear coupled to the chute lever; and a second gear coupled between the first gear and the chute gear, the second gear including a plurality of second gear teeth extending about a periphery of the second gear and configured to engage the plurality of chute gear teeth; wherein the first gear transfers rotation of the chute lever to the second gear; and wherein the second gear transfers rotation to the chute gear via the plurality of second gear teeth and the plurality of chute gear teeth.

The snow blower of any one or more of the embodiments, wherein: the second surface of the chute gear defines a plurality of grooves about a perimeter of the chute gear; the second gear includes at least one engagement assembly for securing the chute gear in a desired position relative to the second gear; and the at least one engagement assembly includes at least one ball and detent includes: a ball for engaging at least one of the plurality of grooves and securing the chute gear in a fixed position, and a biasing member for biasing the at least one ball into a locked position.

The snow blower of any one or more of the embodiments, wherein the at least one engagement assembly includes a plurality of engagement assemblies spaced about a perimeter of the second gear.

The snow blower of any one or more of the embodiments, wherein: the second surface of the chute gear defines a plurality of grooves about a perimeter of the chute gear; the second gear includes at least one engagement assembly for securing the chute gear in a desired position relative to the second gear; and the at least one engagement assembly includes at least one pin and detent includes: a pin for engaging at least one of the plurality of grooves and securing the chute gear in a fixed position, and a biasing member for biasing the at least one pin into a locked position.

The snow blower of any one or more of the embodiments, wherein the at least one pin and detent includes a plurality of pin and detents spaced about a perimeter of the second gear.

The snow blower of any one or more of the embodiments, further comprising a chute base extending from the chute body into the auger housing rearward of the rotatable auger, the chute base at least partially defining the outlet opening.

The snow blower of any one or more of the embodiments, wherein the chute base includes a rear wall extending perpendicular to a direction of travel of the snow blower.

The snow blower of any one or more of the embodiments, wherein: the chute base includes a first width adjacent the chute body and second width opposite the chute body; and the first width is different than the second width.

The snow blower of any one or more of the embodiments, wherein a ratio of the first with to the second width is less than about 0.9.

The snow blower of any one or more of the embodiments, wherein a chute height of the chute body is greater than or equal to about 350 mm and less than or equal to about 450 mm.

The snow blower of any one or more of the embodiments, wherein the chute height of the chute body is about 400 mm.

The snow blower of any one or more of the embodiments, wherein the chute body: a chute flap coupled to an end of the chute body and configured to rotate about a horizontal axis; a flap lever coupled to the chute flap; and a deflector sheet coupled to an interior surface of one or both of the chute flap and the chute body.

The snow blower of any one or more of the embodiments, wherein the deflector sheet is at least partially coupled to the chute flap and at least a portion of the chute flap is configured to rotate about the horizontal axis relative to the chute body.

The snow blower of any one or more of the embodiments, wherein the deflector sheet is at least partially coupled to an interior surface of the chute body and at least a portion of the chute flap is configured to rotate about the horizontal axis relative to the chute flap.

The snow blower of any one or more of the embodiments, wherein a shape of the deflector sheet conforms to a shape of an interior surface of the chute body and an interior surface of the chute flap.

The snow blower of any one or more of the embodiments, further comprising a ratchet assembly coupled to the chute body and the chute flap, the ratchet assembly comprising: a rotatable member coupled to the chute flap and rotatably coupled to the chute body, at least a portion of an exterior surface of the rotatable member including a plurality of teeth; an engagement member including one or more teeth for engaging the plurality of teeth of the rotatable member and securing the chute flap in a desired position; an elongated arm coupled extending from the engagement member; and an actuator coupled to the elongated arm opposite the engagement member.

The snow blower of any one or more of the embodiments, wherein activation of the actuator disengages the one or more teeth of the engagement member from the plurality of teeth of the rotatable member.

The snow blower of any one or more of the embodiments, wherein an end of the deflector sheet at least partially seals a gap between the chute body and the chute flap.

An apparatus as shown and described in one or more embodiments herein.

A system configured to operate in accordance with any one or more of the embodiments disclosed herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A snow blower, comprising:
a frame defining an auger housing, an inlet opening, and an outlet opening, the outlet opening being circumferentially bounded about a chute axis;
a rotatable auger disposed in the auger housing, the rotatable auger mounted to the frame rearward from the inlet opening and below the outlet opening to motivate snow to the outlet opening;
one or more wheels mounted to the frame apart from the rotatable auger to support the snow blower;
a chute body extending from the frame along the chute axis above the outlet opening; and
a chute drivetrain assembly coupled to the frame and the chute body, the chute drivetrain assembly comprising:
a chute gear coupled to the frame and defining at least a portion of the outlet opening, the chute gear configured to rotate the chute body about the chute axis, and
a chute lever operatively coupled to the chute gear for rotating the chute body about the chute axis.

2. The snow blower of claim 1, wherein:
the chute gear includes a first surface adjacent the chute body and a second surface opposite the chute body; and
a plurality of chute gear teeth extend from the second surface of the chute gear about an interior perimeter of the chute gear.

3. The snow blower of claim 2, further comprising:
a first gear coupled to the chute lever; and
a second gear coupled between the first gear and the chute gear, the second gear including a plurality of second gear teeth extending about a periphery of the second gear and configured to engage the plurality of chute gear teeth;
wherein the first gear transfers rotation of the chute lever to the second gear; and
wherein the second gear transfers rotation to the chute gear via the plurality of second gear teeth and the plurality of chute gear teeth.

4. The snow blower of claim 3, wherein:
the second surface of the chute gear defines a plurality of grooves about a perimeter of the chute gear;
the second gear includes at least one engagement assembly for securing the chute gear in a desired position relative to the second gear; and
the at least one engagement assembly includes at least one ball and detent includes:
a ball for engaging at least one of the plurality of grooves and securing the chute gear in a fixed position, and
a biasing member for biasing the at least one ball into a locked position.

5. The snow blower of claim 4, wherein the at least one engagement assembly includes a plurality of engagement assemblies spaced about a perimeter of the second gear.

6. The snow blower of claim 3, wherein:
the second surface of the chute gear defines a plurality of grooves about a perimeter of the chute gear;
the second gear includes at least one engagement assembly for securing the chute gear in a desired position relative to the second gear; and
the at least one engagement assembly includes at least one pin and detent includes:
a pin for engaging at least one of the plurality of grooves and securing the chute gear in a fixed position, and
a biasing member for biasing the at least one pin into a locked position.

7. The snow blower of claim 6, wherein the at least one pin and detent includes a plurality of pin and detents spaced about a perimeter of the second gear.

8. The snow blower of claim 1, further comprising a chute base extending from the chute body into the auger housing rearward of the rotatable auger, the chute base at least partially defining the outlet opening.

9. The snow blower of claim 8, wherein the chute base includes a rear wall extending perpendicular to a direction of travel of the snow blower.

10. The snow blower of claim 8, wherein:
the chute base includes a first width adjacent the chute body and second width opposite the chute body; and
the first width is different than the second width.

11. The snow blower of claim 10, wherein a ratio of the first width to the second width is less than about 0.9.

12. The snow blower of claim 11, wherein a chute height of the chute body is greater than or equal to about 350 mm and less than or equal to about 450 mm.

13. The snow blower of claim 12, wherein the chute height of the chute body is about 400 mm.

14. The snow blower of claim 1, wherein the chute body:
a chute flap coupled to an end of the chute body and configured to rotate about a horizontal axis;
a flap lever coupled to the chute flap; and
a deflector sheet coupled to an interior surface of one or both of the chute flap and the chute body.

15. The snow blower of claim 14, wherein the deflector sheet is at least partially coupled to the chute flap and at least a portion of the chute flap is configured to rotate about the horizontal axis relative to the chute body.

16. The snow blower of claim 14, wherein the deflector sheet is at least partially coupled to an interior surface of the chute body and at least a portion of the chute flap is configured to rotate about the horizontal axis relative to the chute flap.

17. The snow blower of claim 14, wherein a shape of the deflector sheet conforms to a shape of an interior surface of the chute body and an interior surface of the chute flap.

18. The snow blower of claim 14, further comprising a ratchet assembly coupled to the chute body and the chute flap, the ratchet assembly comprising:
a rotatable member coupled to the chute flap and rotatably coupled to the chute body, at least a portion of an exterior surface of the rotatable member including a plurality of teeth;
an engagement member including one or more teeth for engaging the plurality of teeth of the rotatable member and securing the chute flap in a desired position;
an elongated arm coupled extending from the engagement member; and
an actuator coupled to the elongated arm opposite the engagement member.

19. The snow blower of claim 18, wherein activation of the actuator disengages the one or more teeth of the engagement member from the plurality of teeth of the rotatable member.

20. The snow blower of claim 14, wherein an end of the deflector sheet at least partially seals a gap between the chute body and the chute flap.
